(19) United States
(12) Patent Application Publication
(10) Pub. No.: US 2026/0351974 A1
(43) Pub. Date: Nov. 5, 2026

(54) OPERATION PLANNING DEVICE, OPERATION PLANNING METHOD, AND COGENERATION SYSTEM

(71) Applicant: Mitsubishi Electric Corporation, Tokyo (JP)

(72) Inventor: Osamu NAKAJIMA, Tokyo (JP)

(73) Assignee: Mitsubishi Electric Corporation, Tokyo (JP)

(21) Appl. No.: 19/105,057

(22) PCT Filed: Aug. 26, 2022
(86) PCT No.: PCT/JP2022/032143

§ 371 Date: Feb. 20, 2025

(51) Int. Cl. H02J 3/175; H02J 3/28; H02J 13/12; H02J 103/30

(52) U.S. Cl. CPC H02J 3/175; H02J 3/28; H02J 13/12; H02J 2103/30

(57) ABSTRACT

An operation planning device includes: a data obtaining unit configured to obtain at least one of registration data, measurement data, and external data; an energy remaining amount obtaining unit; a load prediction unit; and an installation operation planning unit configured to create, based on the load of the electricity load installation and the load of the heat load installation that are predicted by the load prediction unit, operation plans for the power source installation and the heat source installation that are feasible with the remaining amount of the available energy that is obtained by the energy remaining amount obtaining unit.

### TECHNICAL FIELD

The present disclosure relates to an operation planning device, an operation planning method, and a cogeneration system that perform energy management for an installation or a region at the time of disaster.

### BACKGROUND ART

In a facility such as a building or a factory, a load installation such as an air-conditioning apparatus or a lighting device, a power and heat source such as a cogeneration system, a power storage installation such as a storage battery, a heat storage installation such as a hot-water tank, and a variable power source such as a solar power generation are introduced. To perform control for checking an operational status, detecting an abnormality, and achieving energy saving in such installations as described above, in some cases, a monitoring control device for the installations is introduced. A manager of the installations causes the monitoring control device to analyze operational statuses of the installations, perform manual control, perform control proposed by the monitoring control device, and perform automatic control of the monitoring control device, thereby achieving purposes related to operations of the installations.

In addition, in an energy plant in a region that supplies energy to a plurality of facilities installed in a region, a heat source unit such as a refrigerating machine or a boiler, and a power and heat source such as a cogeneration system are introduced. Furthermore, a power storage installation such as a storage battery, a heat storage installation such as a heat storage tank, and a variable power source such as a solar power generation are introduced in the energy plant. To perform control for checking an operational status, detecting an abnormality, and achieving energy saving in such facilities as described above, a monitoring control device for installations is introduced.

An installation such as a power source, a heat source, or a power and heat source, which is installed in a facility such as a building, a factory, or an energy plant, is supplied with electricity or fuel from the outside, performs energy conversion as appropriate, and supplies energy as electricity, cooling energy, heating energy, hot water, or vapor to a load installation.

For a monitoring control device, the following method is proposed: operation planning and control for installations are performed to prolong the duration of electricity supply in the case where supply of electricity from the outside is stopped at the time of disaster (see, for example, Patent Literature 1).

For example, Patent Literature 1 proposes a monitoring control device that optimizes an operation time of a load installation based on a load prediction when a commercial power failure occurs and prolongs the operating time of a power generator.

### CITATION LIST

### Patent Literature

Patent Literature 1: Japanese Patent No. 6563257

### SUMMARY OF INVENTION

### Technical Problem

In such an existing monitoring control device as described in Patent Literature 1, load control is control of a load installation that focuses only on electricity, and it is therefore impossible to perform load control in consideration of utilization of heat such as cooling energy, heating energy, hot water, and vapor.

For example, because a cogeneration system generates electricity and heat, as the generation ratio of heat to electricity becomes closer to the heat-to-electricity ratio, which is the usage ratio of heat to electricity, the energy can be more efficiently utilized without waste. Therefore, if the heat-to-electricity ratio can be improved by controlling the load, there is a possibility that the duration of energy supply by the cogeneration system can be prolonged. However, in Patent Literature 1, because improvement of the heat-to-electricity ratio is not considered, the optimal operation of the entire system that includes not only utilization of electricity but also utilization of heat cannot be achieved.

The present disclosure is applied to solve the above problem, and relates to an operation planning device, an operation planning method, and a cogeneration system that are capable of creating an operation plan for controlling load to improve the heat-to-electricity ratio depending on the situation and thereby capable of prolonging the duration of energy supply at the time of disaster.

### Solution to Problem

An operation planning device according to an embodiment of the present disclosure creates operation plans for a power source installation and a heat source installation that operate an electricity load installation and a heat load installation, respectively, which are installed in a facility or a region. The operation planning device includes: a data obtaining unit configured to obtain at least one of registration data registered in advance as data regarding the facility or the region, input data input from an outside, measurement data measured by a sensor installed in the facility or the region, and external data obtained from the outside via communication; an energy remaining amount obtaining unit configured to obtain a remaining amount of an available energy that is allowed to be used in the facility or the region during an energy sustainable target time indicating a desired duration of continuous operations of the power source installation and the heat source installation; a load prediction unit configured to tentatively determine an operational method for the electricity load installation, an operational method for the heat load installation, and an operational method for the facility or the region based on the data obtained by the data obtaining unit, and predict a load of the electricity load installation and a load of the heat load installation that are required during the energy sustainable target time, based on the operational methods; and an installation operation planning unit configured to create, based on the load of the electricity load installation and the load of the heat load installation that are predicted by the load prediction unit, operation plans for the power source installation and the heat source installation that are feasible with the remaining amount of the available energy that is obtained by the energy remaining amount obtaining unit.

A cogeneration system according to another embodiment of the present disclosure creates operation plans for a power source installation and a heat source installation that operate an electricity load installation and a heat load installation, respectively, which are installed in a facility or a region. The cogeneration system includes: a data obtaining unit configured to obtain at least one of registration data registered in advance as data regarding the facility or the region, input data input from an outside, measurement data measured by a sensor installed in the facility or the region, and external data obtained from the outside via communication; an energy remaining amount obtaining unit configured to obtain a remaining amount of an available energy that is allowed to be used in the facility or the region during an energy sustainable target time indicating a desired duration of continuous operations of the power source installation and the heat source installation; a load prediction unit configured to tentatively determine the operational method for the electricity load installation, the operational method for the heat load installation, and the operational method for the facility or the region based on the data obtained by the data obtaining unit, and predict a load of the electricity load installation and a load of the heat load installation that are required during the energy sustainable target time, based on the operational methods; an installation operation planning unit configured to create, based on the load of the electricity load installation and the load of the heat load installation that are predicted by the load prediction unit, operation plans for the power source installation and the heat source installation; an energy consumption amount calculation unit configured to calculate amounts of energies that are consumed by the power source installation and the heat source installation during the energy sustainable target time, based on the operation plans created by the installation operation planning unit; a load control examination unit configured to change a ratio between heat and electricity that are consumed by the electricity load installation and the heat load installation to reduce the amounts of the consumed energies that are calculated by the energy consumption amount calculation unit, and update, based on the ratio, at least one of the operational method for the electricity load installation, the operational method for the heat load installation, and the operational method for the facility or the region; and an output unit configured to output the at least one of the operational method for the electricity load installation, the operational method for the heat load installation, and the operational method for the facility or the region that is updated by the load control examination unit. At least one of the data obtaining unit, the energy remaining amount obtaining unit, the load prediction unit, the installation operation planning unit, the energy consumption amount calculation unit, the load control examination unit, and the output unit belongs to a first group. At least one of remaining ones of the data obtaining unit, the energy remaining amount obtaining unit, the load prediction unit, the installation operation planning unit, the energy consumption amount calculation unit, the load control examination unit, and the output unit belongs to a second group. The first group is provided outside the facility or the region.

An operation planning method according to still another embodiment of the present disclosure is an operation planning method of creating operation plans for a power source installation and a heat source installation that operate an electricity load installation and a heat load installation, respectively, that are installed in a facility or a region. The operation planning method includes: obtaining at least one of registration data registered in advance as data regarding the facility or the region, input data input from an outside, measurement data measured by a sensor installed in the facility or the region, and external data obtained from the outside via communication; obtaining a remaining amount of an available energy that is allowed to be used in the facility or the region during an energy sustainable target time indicating a desired duration of continuous operations of the power source installation and the heat source installation; tentatively determining the operational method for the electricity load installation, the operational method for the heat load installation, and the operational method for the facility or the region based on the obtained data and predicting a load of the electricity load installation and a load of the heat load installation that are required during the energy sustainable target time based on the operational methods; creating, based on the predicted load of the electricity load installation and the predicted load of the heat load installation, operation plans for the power source installation and the heat source installation; calculating amounts of energies that are consumed by the power source installation and the heat source installation during the energy sustainable target time, based on the created operation plans; changing a ratio between heat and electricity that are consumed by the electricity load installation and the heat load installation to reduce the calculated amounts of the consumed energies, and updating, based on the ratio, at least one of the operational method for the electricity load installation, the operational method for the heat load installation, and the operational method for the facility or the region; and outputting at least one of the operational method for the electricity load installation, the operational method for the heat load installation, and the operational method for the facility or the region that is updated by the load control examination unit.

### Advantageous Effects of Invention

In the operation planning device, the operation planning method, and the cogeneration system according to the embodiments of the present disclosure, because operation plans for the power source installation and the heat source installation are created to achieve an energy sustainable target time and the load is controlled, energy supply can be continued for a desired time by the entire system utilizing electricity energy and heat energy.

### BRIEF DESCRIPTION OF DRAWINGS

FIG. 1 illustrates a configuration of a monitoring control device 11 installed in a cogeneration system 100 according to Embodiment 1.

FIG. 2 illustrates a connection relationship between an electricity load installation 1, a heat load installation 2, a power source installation 3, and a heat source installation 4 in the cogeneration system 100 according to Embodiment 1.

FIG. 3 illustrates a connection relationship between a power and heat source installation 30, the electricity load installation 1, the heat load installation 2, and the heat source installation 4 in the cogeneration system 100 according to Embodiment 1.

FIG. 4 illustrates an example in which an energy sustainable target time is extended by reduction of the usage of energy that results from a change in a heat-to-electricity ratio in the cogeneration system 100 according to Embodiment 1.

FIG. 5 illustrates an example in which the energy sustainable target time is extended by reduction of the usage of energy that results from a change in the heat-to-electricity ratio that is made by increasing a demand D1 of electricity and decreasing a demand of heat of hot water in the cogeneration system 100 according to Embodiment 1.

FIG. 6 is a configuration diagram illustrating a configuration of an operation planning device 13 according to Embodiment 1.

FIG. 7 is a flowchart illustrating the flow of processes that are executed by the operation planning device 13 according to Embodiment 1 at the time of outputting an operational method for the electricity load installation 1, that for the heat load installation 2, and, and that of a facility 5A.

FIG. 8 is a configuration diagram illustrating configurations of a monitoring control device 11B and a monitoring control device 11C installed in a cogeneration system 100 according to Embodiment 2.

FIG. 9 is a configuration diagram illustrating a configuration of the operation planning device 13 according to Embodiment 2.

FIG. 10 is a flowchart illustrating the flow of processes in the case where the operation planning device 13 according to Embodiment 2 outputs an operational method for the electricity load installation 1, that for the heat load installation 2, and, and those of facilities 5B and 5C or that of a region 50.

FIG. 11 is a flowchart illustrating the flow of processes in the case where an operation planning device 13 according to Embodiment 3 outputs an operational method for the electricity load installation 1, an operational method for the heat load installation 2, and operational methods for the facilities 5B and 5C or an operational method for the region 50.

FIG. 12 is a flowchart indicating the flow of processes in the case where an operation planning device 13 according to Embodiment 4 outputs an operational method for the electricity load installation 1, an operational method for the heat load installation 2, and operational methods for the facilities 5B and 5C or an operational method for the region 50.

FIG. 13 is a graph in which effect indexes resulted from optimization with respect to multiple energy supply target times that is performed by the operation planning device 13 according to Embodiment 4 are plotted.

FIG. 14 illustrates the case where an operational method A and an operational method B of multiple operational methods in the graph of FIG. 13 are compared with each other.

FIG. 15 illustrates a connection relationship between the electricity load installation 1, the heat load installation 2, the power source installation 3, the heat source installation 4, a power storage installation 14, and a heat storage installation 15 in the cogeneration system 100 according to Embodiment 5.

FIG. 16 illustrates an example in which energy sustainable target time is extended by reduction of the usage of energy that results from a change in the heat-to-electricity ratio in the cogeneration system 100 according to Embodiment 5.

FIG. 17 is a configuration diagram illustrating a configuration of an operation planning device 13 according to Embodiment 6.

FIG. 18 is a plan view illustrating an example of the configuration of the facility 5A provided with the operation planning device 13 according to Embodiment 1.

### DESCRIPTION OF EMBODIMENTS

An operation planning device, an operation planning method, and a cogeneration system according to the embodiments of the present disclosure will be described below with reference to the drawings. The present disclosure is not limited to the following embodiments, and various modifications can be made without departing from the gist of the present disclosure. Moreover, the present disclosure encompasses all combinable ones of configurations that are described regarding the following embodiments and the modifications. Furthermore, in each of figures in the drawings, components that are the same as or equivalent to those in a previous figure or previous figures are denoted by the same reference signs. The same is true of the entire text of the specification. In addition, with regard to a plurality of devices or steps of the same type that are distinguished by suffixes (uppercase alphabets at the ends of their reference signs), in the case where the devices or steps are not particularly required to be distinguished or specified, the suffixes will be omitted in some cases. It should be noted that in the figures, a relationship or relationships in size between components or the shapes of the components may be different from actual ones.

### Embodiment 1

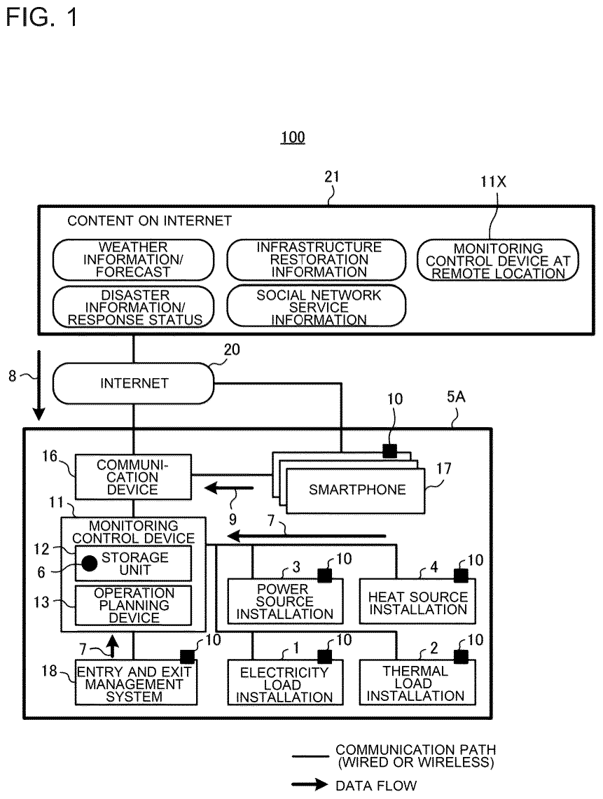

FIG. 1 illustrates a configuration of a monitoring control device 11 provided in a cogeneration system 100 according to Embodiment 1. The cogeneration system 100 is installed for a facility 5A, for example. The monitoring control device 11 is installed in the facility 5A. The facility 5A is, for example, a building or a factory. In the facility 5A, an electricity load installation 1, a heat load installation 2, a power source installation 3, and a heat source installation 4 are further installed. An entry and exit management system 18 is installed at a doorway of the facility 5A. A facility manager or user of the facility 5A carries a smartphone 17. When data 9 is input to the smartphone 17 by the facility manager or user, the smartphone 17 transmits the input data 9 to the monitoring control device 11.

The monitoring control device 11, the electricity load installation 1, the heat load installation 2, the power source installation 3, the heat source installation 4, and the entry and exit management system 18 are connected to the smartphone 17 via a communication path so that they can communicate with the smartphone 17. The communication path is a wireless network or a combination of wired and wireless networks. Furthermore, the monitoring control device 11 is connected to an Internet 20 via a communication device 16.

Furthermore, a plurality of sensors 10 are installed in the facility 5A. The sensors 10 are configured to measure various kinds of data and transmit measurement data 7 to the monitoring control device 11. The sensors 10 are, for example, a sensor incorporated in an installation in the facility 5A, a sensor additionally installed for the installation in the facility 5A, and a sensor installed independently of the installation in the facility 5A. It should be noted that the installations are, for example, the electricity load installation 1, the heat load installation 2, the power source installation 3, the heat source installation 4, and the entry and exit management system 18. In addition, the installations are, for example, a switchboard or a power receiving installation that supplies a power source to each of the installations such as the electricity load installation 1, the heat load installation 2, the power source installation 3, the heat source installation 4, and the entry and exit management system 18, or the smartphone 17 that the facility manager or user carries. Furthermore, of the plurality of sensors 10, sensors 10 installed independently are each, for example, a thermometer that measures a temperature in or outside a room or a hygrometer that measures a humidity in or outside the room.

The monitoring control device 11 includes a storage unit 12 and an operation planning device 13. The storage unit 12 stores in advance, registration data 6 including data on the building design of the facility 5A and data on the installation design of each of the electricity load installation 1, the heat load installation 2, the power source installation 3, and the heat source installation 4. The registration data 6 includes, for example, data on the total floor area of the facility 5A, data on the intended use of the facility 5A, and data on the installation specifications of each of the electricity load installation 1, the heat load installation 2, the power source installation 3, and the heat source installation 4. The operation planning device 13 proposes operation plans for the power source installation 3 and the heat source installation 4 and a management method of the facility 5A for the facility manager by using the registration data 6 stored in the storage unit 12 and the measurement data 7, which can be collected from the sensors 10.

The monitoring control device 11 stores the registration data 6 in the storage unit 12 in advance. Thus, based on the registration data 6, the monitoring control device 11 can refer to the design information on the facility 5A and the installations 1 to 4, such as the total floor area and the intended use of the facility 5A and the installation configurations of the installations 1 to 4.

Furthermore, the monitoring control device 11 can obtain the measurement data 7 from each of the sensors 10. In addition, the monitoring control device 11 can obtain external data 8 that is obtained through communication with an external device via the Internet 20. The external data 8 is data that is obtained from content 21 on the Internet 20. As illustrated in FIG. 1, as examples of the content 21, the following are present: weather information; weather forecast; infrastructure restoration information; information on another monitoring control device 11X installed at a remote location; disaster information; disaster response status: and information on social network service. In such a manner, the external data 8 contains, for example, information on weather and information on disaster.

Furthermore, the monitoring control device 11 can obtain input data 9 that is input by the facility manager or user to the monitoring control device 11 via an interface (not illustrated) provided in the monitoring control device 11. Examples of the interface provided in the monitoring control device 11 are a keyboard, a mouse, and a display that are connected to a computing device that fulfills each of the functions of the monitoring control device 11. Furthermore, other examples of the interface provided in the monitoring control device 11 are a computing device and a smartphone 17 that can access to functions of a web server that are provided by the monitoring control device 11.

The above data 6 to 9 are used in the monitoring control device 11 in order to determine the operational method for the facility 5A at the time of disaster. However, if sufficient data is present and available to determine the operational method, not all the data 6 to 9 are necessary. That is, the monitoring control device 11 uses at least one of the data 6 to 9 as needed. The following description is made by referring to by way of example the case where data on the number of evacuees at the time of disaster is necessary to determine the operational method for the facility 5A, such as how to accommodate evacuees in each of spaces within the facility 5A during disaster. In this case, the following three cases are conceivable, for example.
(1) An anticipated number of people determined in advance is stored in the registration data 6 held in the monitoring control device 11, and the number of people stored in the registration data 6 is used as the number of evacuees.
(2) The sensor 10 attached to the entry and exit management system 18 measures the number of people that stay in the facility 5A, and the measurement data 7 obtained by this measurement is used as the number of evacuees.
(3) The facility manager of the facility 5A counts the number of people at the actual spot and inputs the number using the smartphone 17. Then, the input data 9 is transmitted to the monitoring control device 11 and is used as the number of evacuees.

As described above, the monitoring control device 11 may use, for example, one of the registration data 6, the measurement data 7, and the input data 9 to determine the operational method for the installation.

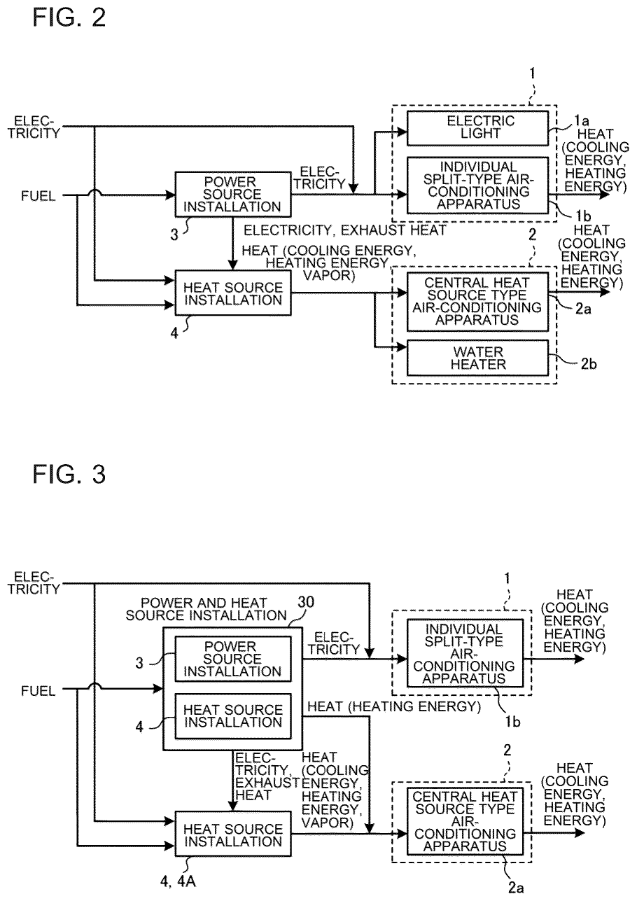

FIG. 2 illustrates a connection relationship between the electricity load installation 1, the heat load installation 2, the power source installation 3, and the heat source installation 4 in the cogeneration system 100 according to Embodiment 1. The power source installation 3 is connected to the electricity load installation 1 and the heat source installation 4. In addition, the heat source installation 4 is connected to the heat load installation 2.

The power source installation 3 generates electricity by consuming fuel. The fuel is normally supplied to the power source installation 3 from the outside of the facility 5A. However, when the fuel is not supplied from the outside at the time of disaster, the fuel stored in advance in the facility 5A is consumed. As examples of the power source installation 3, a micro gas turbine generator and a diesel generator are present. The electricity generated by the power source installation 3 is supplied mainly to the electricity load installation 1, which operates by consuming electricity. The main consumption energy of the electricity load installation 1 is electricity. However, in this case, the electricity load installation 1 includes an installation that operates by receiving auxiliary supply of heat. As examples of an installation classified as the electricity load installation 1, an electric light 1a and an individual split-type air-conditioning apparatus 1b are present. The electric light 1a is installed in a space to be illuminated and generates light to illuminate the space. The individual split-type air-conditioning apparatus 1b is installed in a space to be air-conditioned and supplies heat (cooling energy or heating energy) to air in the space. The individual split-type air-conditioning apparatus 1b includes a heat exchanger, and causes heat exchange to be performed between refrigerant that flows in the heat exchanger and air that flows around the heat exchanger. In addition, the electricity generated by the power source installation 3 can be supplied to the heat source installation 4. Furthermore, an exhaust heat secondarily generated when the power source installation 3 generates electricity can be supplied to the heat source installation 4 and be effectively utilized thereby.

The heat source installation 4 generates heat (cooling energy, heating energy, and vapor) upon reception of electricity or fuel, or both of electricity and fuel. The electricity and fuel are normally supplied to the heat source installation 4 from the outside of the facility 5A. However, when the electricity and fuel are not supplied from the outside at the time of disaster, the fuel stored in advance in the facility 5A is consumed or the electricity supplied from the power source installation 3 is used for operation. The heat source installation 4 is, for example, a heat source device such as a chiller or a boiler. As other examples of the heat source installation 4, an exhaust heat recovery heat exchanger and an exhaust heat absorption refrigerating machine, which are operated by receiving an exhaust heat from the power source installation 3, are present. Heat generated by the heat source installation 4 is supplied mainly to the heat load installation 2, which consumes heat. The main consumption energy of the heat load installation 2 is heat. However, in this case, as the heat load installation 2, an installation that operates by receiving auxiliary supply of electricity can also be used. As examples of an installation classified as the heat load installation 2, a central heat source type air-conditioning apparatus 2a and a water heater 2b are present. The central heat source type air-conditioning apparatus 2a supplies a cooling energy or a heating energy to the air in a room to perform cooling or heating in the room. The central heat source type air-conditioning apparatus 2a supplies a cold water or a hot water to a heat exchanger, and, the heat exchanger causes heat exchange between the indoor air and the cold water or between the indoor air and the hot water. The water heater 2b supplies a heating energy to water and supplies the heated water to a hot water supply tank.

FIG. 3 illustrates a connection relationship between a power and heat source installation 30, the electricity load installation 1, the heat load installation 2, and the heat source installation 4 in the cogeneration system 100 according to Embodiment 1. Referring to FIG. 3, the power and heat source installation 30 in which the power source installation 3 and the heat source installation 4 as illustrated in FIG. 2 are configured to operate as a single unit is installed in the facility 5A. The power and heat source installation 30 generates electricity and heat upon reception of fuel. As examples of the power and heat source installation 30, a gas cogeneration system and a fuel battery are present. In the example as illustrated in FIG. 3, a heat source installation 4A is installed along with the power and heat source installation 30. In this case, although the heat source installation 4A is distinguished from the heat source installation 4 included in the power and heat source installation 30 by adding the alphabet “A” to the end of the reference sign, the configuration and the operation of the heat source installation 4A are basically the same as those of the heat source installation 4. As described above with reference to FIG. 2, the heat source installations 4 and 4A generate heat (cooling energy, heating energy, and vapor) upon reception of electricity or fuel, or both of electricity and fuel. Referring to FIG. 3, as in the case illustrated in FIG. 2, electricity and an exhaust heat generated by the power and heat source installation 30 are utilized in the heat source installation 4A. Electricity generated mainly by the power source installation 3 of the power and heat source installation 30 is consumed by the electricity load installation 1, and heat generated mainly by the heat source installation 4 of the power and heat source installation 30 is consumed by the heat load installation 2. Heat generated by the heat source installation 4A is consumed by the heat load installation 2. As described above, the operations of the power source installation 3 and the heat source installation 4 included in the power and heat source installation 30 and the operation of the heat source installation 4A installed along with the power and heat source installation 30 are the same as those of the power source installation 3 and the heat source installation 4 as illustrated in FIG. 2.

The power source installation 3 and the heat source installation 4 are provided in combination. In this case, the power source installation 3 and the heat source installation 4 may be installed as separate installations in the example of FIG. 2, or may be operated as a single unit in the example of FIG. 3. However, in either case, the power source installation 3 and the heat source installation 4 are configured as a whole system such that he power source installation 3 and the heat source installation 4 are capable of meeting demands of the electricity load installation 1 and the heat load installation 2 and an exhaust heat generated in the power source installation 3 is utilized in the heat source installation 4. Such a system is referred to as “cogeneration system 100”.

The cogeneration system 100 generates electricity and heat but the efficiency of the cogeneration system 100 varies depending on the ratio of energy amounts between the electricity and the heat. When generating electricity, the power source installation 3 also generates exhaust heat. When the power source installation 3 generates electricity depending on the usage of the electricity load installation 1, the amount of the exhaust heat is determined according to characteristics of the power source installation 3. The exhaust heat is converted by the heat source installation 4 such that the exhaust heat can be utilized in the heat load installation 2. An amount of the exhaust heat that exceeds the amount of the exhaust heat to be consumed by the heat load installation 2 is unnecessary and thus disposed of without being effectively utilized. The “disposed of” in this case means a natural heat radiation or a heat radiation via a cooling tower. Consequently, because an amount of the disposed-of exhaust heat of the energy of the fuel supplied into the power source installation 3 is an energy not to be effectively utilized, and the energy efficiency of the entire system is reduced.

The ratio between electricity generated by the cogeneration system 100 and heat generated with the generation of electricity is referred to as “heat-to-electricity ratio”. In this case, the “heat” encompasses both exhaust heat generated by the power source installation 3 and heat generated by the heat source installation 4. The heat-to-electricity ratio of the cogeneration system 100 is determined depending on the characteristics of the cogeneration system 100. The heat-to-electricity ratio may be a fixed value or a variable that can change within a certain range. Whether the heat-to-electricity ratio is a fixed value or a variable depends on the characteristics of the cogeneration system 100. However, because it is impossible to convert all of the energy of the fuel supplied to the power source installation 3 into electricity in the principle of the power generator included in the power source installation 3, the heat-to-electricity ratio is limited to certain values.

The cogeneration system 100 can further reduce loss when utilizing the energy, as the ratio between the heat and the electricity used in the electricity load installation 1 and the heat load installation 2 becomes closer to the heat-to-electricity ratio of the cogeneration system 100. In general, in a facility such as an office building, the usage of the electricity load installation 1 is large and the usage of heat in the heat load installation 2 is small. Thus, in some cases, the heat-to-electricity ratio does not match with that of an existing cogeneration system 100. By contrast, in a facility such as a hospital or a hotel where the usage of heat is large, in many cases, the heat-to-electricity ratio becomes close to that of the existing cogeneration system 100 and thus efficient energy utilization can be achieved. In such a manner, in the cogeneration system 100, the efficiency, that is, the ratio of the effectively utilized energy to the supplied energy varies based on the usage of the heat and the electricity in the electricity load installation 1 and the heat load installation 2 on the energy use side.

Next, an energy utilization in the facility 5A at the time of disaster will be described. Although during disaster, an actual usage of the energy in the facility 5A varies depending on the disaster level, the following description is made with respect to the case where no electricity or no fuel is supplied from the outside of the facility 5A or the case where the amount of electricity or fuel to be supplied is limited. The case where the amount of electricity or fuel to be supplied is limited corresponds to, for example, the case where electricity can be supplied from a storage battery during a blackout, the case where no additional fuel can be supplied but a stockpile of fuel is available, or the case where rolling blackouts occur and thus there are time periods when electricity is available and when no electricity is available.

At the time of disaster, “energy sustainability target time”, which is a target or a benchmark for a continuous independent operation, is given to the facility 5A in response to a request from the age or the area.

Although it depends on the scale of a disaster, rescue of survivors is given priority for 72 hours after the occurrence of the disaster. For this reason, it is said that a full-fledged offering of relief goods and aid for evacuees will start after 72 hours after the occurrence of the disaster. In addition, because it takes a tremendous time to restore energy infrastructures such as electricity and gas, it is desirable that the facility 5A ensure energy independence for at least 72 hours, or ideally for one week. In such a manner, the “energy sustainable target time” is a target time period in which the facility 5A can continue the operation independently in terms of energy without receiving relief goods or aid. It should be noted that the above values, such as 72 hours or one week, are merely examples and the energy sustainable target time is not limited to those values.

When the facility 5A continues a self-sustained operation in which the facility 5A operates independently in energy for the “energy sustainable target time” while energy supply is limited, usage of energy needs to be limited according to circumstances. For example, in the case where fuel is consumed to drive a power generator in order to meet demands of electricity, if future demands of electricity are known, an operable time period during which the power generator can operate can be estimated based on the remaining amount of the fuel and the characteristics of the power generator. In addition, when the estimated operable time period is shorter than the “energy sustainable target time”, meeting some demands of electricity is given up, electricity is supplied only in response to a selected demand according to the degree of importance or urgency or according to the determination by a person.

As described above, the facility 5A includes the electricity load installation 1 and the heat load installation 2. In the cogeneration system 100, the efficiency varies depending on the heat-to-electricity, as described above. When supply of energy is limited, the self-sustained operation of the facility 5A can be continued for a predetermined “energy sustainable target time” by changing the ratio between the usage of electricity in the electricity load installation 1 and the usage of heat in the heat load installation 2, and the overall usage of electricity and heat.

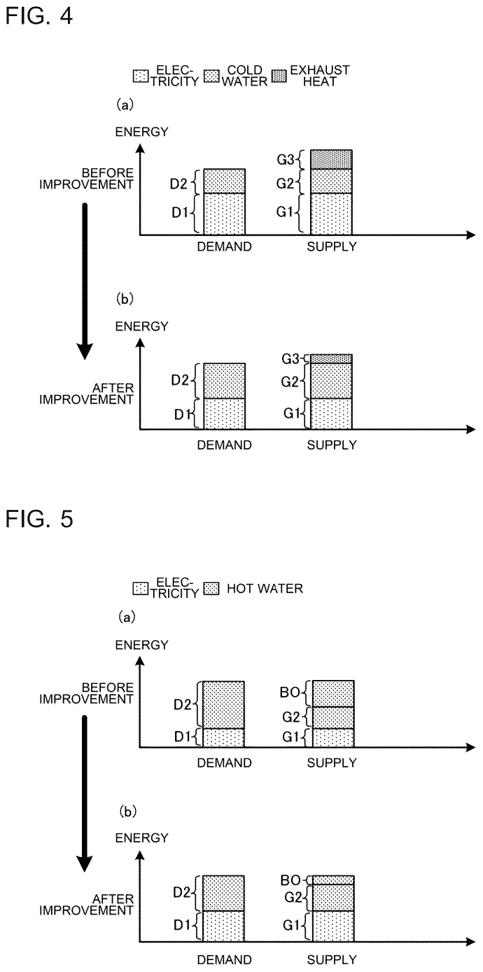

FIG. 4 illustrates an example in which the energy sustainable target time is extended by changing the heat-to-electricity ratio in the cogeneration system 100 according to Embodiment 1 to reduce the usage of energy. FIG. 4, (a) indicates a graph of a heat-to-electricity ratio that has not yet been improved, and FIG. 4, (b) indicates a graph of the heat-to-electricity ratio that has been improved. Each of (a) and (b) in FIG. 4 indicates two bars that represent demand and supply, respectively. The following description is made by referring to by way of example the configuration of FIG. 3 in which the power and heat source installation 30 is installed.

As illustrated in the left bar in FIG. 4, (a), before the improvement, demand D1 of electricity and demand D2 of cold water as heat are present. The demand D1 of electricity is higher than the demand D2 of cold water. At this time, as illustrated in the right bar in FIG. 4, (a), the demand D1 of electricity is satisfied by supply G1 of electricity generated in the power and heat source installation 30. The demand D2 of cold water is satisfied by conversion of an exhaust heat G2 generated in the power and heat source installation 30 into cold water via an exhaust-heat supply type absorption refrigerating machine that serves as the heat source installation 4. Of the exhaust heat from the power and heat source installation 30, exhaust heat G3 that is not used in the generation of cold water is present, and is disposed of without being used.

Thus, it is preferable that as an improvement, the demand D1 of electricity be decreased and the demand D2 of cold water be increased in such a manner as to reduce the exhaust heat G3. To achieve such an improvement, the operational methods for the installations 1 to 4 are changed.

Specifically, for the individual split-type air-conditioning apparatuses included in the electricity load installations 1, an area or areas not to be air-conditioned are set and the operation or operations of an individual split-type air-conditioning apparatus or apparatuses installed in the area or areas are stopped to reduce the demand D1 of electricity. By contrast, the operation amount of the central heat source type air-conditioning apparatus 2a included in the heat load installation 2 in the area where the central heat source type air-conditioning apparatus 2a is installed is increased. In such a manner, the operational methods for the electricity load installation 1 and the heat load installation 2 are changed. These changes can be made by changing the operational method for the facility 5A, for example, by simply stopping individual split-type air-conditioning apparatuses or by changing the evacuation space for evacuees to the area in which the central heat source type air-conditioning apparatus operates. By changing the evacuation space for evacuees to the area in which the central heat source type air-conditioning apparatus performs air-conditioning, individual split-type air-conditioning apparatuses do not need to be operated and the operation amount of the central heat source type air-conditioning apparatus is increased. The change in the operational methods for the electricity load installation 1 and the heat load installation 2 is made by changing the operational method for the facility 5A in such a manner as to bring about such a situation in the facility 5A as described above.

As indicated in the left bar of FIG. 4, (b), after the improvement, the demand D1 of electricity is decreased and the demand D2 of cold water is increased, as compared with those before the improvement. As indicated in the right bar in FIG. 4, (b), the demand D1 of electricity is satisfied by the supply G1 of the electricity generated in the power and heat source installation 30. The demand D2 of cold water is satisfied by conversion of the exhaust heat G2 generated in the power and heat source installation 30 into cold water via the exhaust-heat supply type absorption refrigerating machine that serves as the heat source installation 4. Although the exhaust heat from the power and heat source installation 30 includes the exhaust heat G3 that is not used in the generation of cold water, the exhaust heat G3 is decreased, as compared with that before the improvement.

As described above, because after the improvement, the electricity consumed by the individual split-type air-conditioning apparatuses 1b is reduced, the demand D1 of electricity is reduced. By this reduced amount of electricity, the power generation amount of the power and heat source installation 30 can be reduced. That is, the fuel that is to be consumed by the power and heat source installation 30 is reduced.

The demand D2 of cold water is not changed simply in the case where the individual split-type air-conditioning apparatuses 1b are in the stopped state. The demand D2 of cold water is increased when the evacuation space for evacuees is changed and the operation amount of the central heat source type air-conditioning apparatus 2a is increased. In either case, because the demand D1 of electricity is decreased and the demand D2 of cold water remains unchanged or is increased, the rate of usage of heat to electricity is increased.

Because the amount of cold water generated from the exhaust heat in the power and heat source installation 30 is increased by the amount of increase in the demand D2 of cold water, the usage of the exhaust heat G2 is increased. Although the amount of exhaust heat is decreased by the amount of decrease in the power generation amount, the demand D2 of cold water can be satisfied without shortage when the sum of the absolute value of the decreased amount of the exhaust heat and the amount of increase in the usage of exhaust heat falls below the exhaust heat G3 before the improvement.

When the demand D2 of cold water is increased by changing the evacuation space for evacuees and increasing the operation amount of the central heat source type air-conditioning apparatus 2a, the fuel to be consumed by the power and heat source installation 30 can be decreased while satisfying the demands D1 and D2 to be required. Furthermore, by combining a method of reducing the demand of electricity simply by stopping the individual split-type air-conditioning apparatuses with a method of changing the evacuation space, the fuel consumption can be further reduced.

As described above, by changing the controls of the installations 1 to 4 or changing the operational method for the facility 5A to change the heat-to-electricity ratio of the demands D1 and D2, the consumption of energy is reduced and the “energy sustainable target time” in which the facility 5A continues the self-sustained operation can be prolonged.

For the controls of the installations 1 to 4, in some cases, not only a decrease in the demand D1 of electricity but also an increase in the demand D1 of electricity are examined.

FIG. 5 illustrates an example in which the energy sustainable target time is extended by reduction of the usage of energy that results from a change in the heat-to-electricity ratio that is made by increasing the demand D1 of electricity and decreasing the demand of heat of hot water in the cogeneration system 100 according to Embodiment 1. FIG. 5, (a) indicates a graph of the heat-to-electricity ratio that has not yet been improved, and FIG. 5, (b) indicates a graph of the heat-to-electricity ratio that has been improved. Each of (a) and (b) in FIG. 5 include two bars that indicate demand and supply, respectively.

As illustrated in the left bar of FIG. 5, (a), before the improvement, the demand D1 of electricity and the demand D2 of hot water as heat are present. The demand D1 of electricity is lower than the demand D2 of hot water. At this time, the demand D1 of electricity is satisfied by the supply G1 of electricity generated in the power and heat source installation 30. For the demand D2 of hot water, hot water obtained by conversion of the exhaust heat of the power and heat source installation 30 via a heat exchanger is supplied but this supply is insufficient to meet the demand. Thus, a hot water BO is generated by the boiler included in the heat source installation 4 to make up for the insufficient supply.

As indicated in the left bar of FIG. 5, (b), after the improvement, the demand D1 of electricity is increased and the demand D2 of hot water is decreased, as compared with those before the improvement.

As described above, after the improvement, by changing the controls of the installations 1 to 4 or changing the operational method for the facility 5A in such a manner as to increase the demand D1 of electricity, the power generation amount of the power and heat source installation 30 is increased. As a result, the consumption amount of fuel in the power and heat source installation 30 is increased. On the other hand, because the exhaust heat generated in the power and heat source installation 30 is also increased, the hot water generated from the exhaust heat is also increased. The shortage of the supply amount of hot water for the demand D2 of hot water is thus reduced and the operation of the boiler included in the heat source installation 4 is reduced. Therefore, the consumption amount of the fuel by the boiler included in the heat source installation 4 is reduced. The consumption amount of the fuel can be reduced by an amount by which an increase in the fuel consumption amount of the power and heat source installation 30 is smaller than a decrease in the fuel consumption amount of the boiler included in the heat source installation 4.

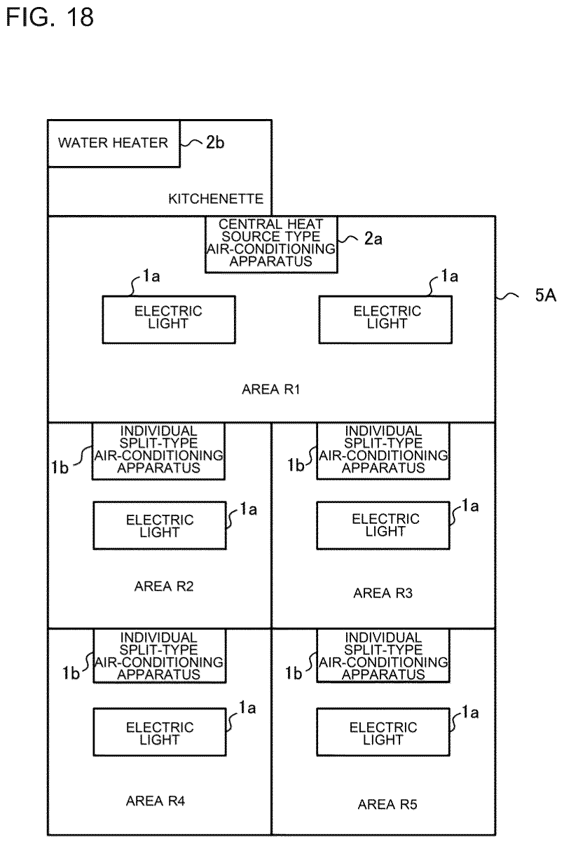

FIG. 18 is a plan view illustrating an example of the configuration of the facility 5A provided with the operation planning device 13 according to Embodiment 1. As illustrated in FIG. 18, the facility 5A has multiple areas R1 to R5. The areas R1 to R5 are living spaces in the facility 5A and are partitioned off by, for example, walls. In each of the areas R1 to R5, an electric light 1a included in the electricity load installation 1 is installed. In addition, in the area R1, the central heat source type air-conditioning apparatus 2a included in the heat load installation 2 is installed. By contrast, in the areas R2 to R5, respective individual split-type air-conditioning apparatuses 1b included in the electricity load installation 1 are installed.

Therefore, when the operational method for the facility 5A is determined such that all evacuees are evacuated to stay in the area R1, it is possible that the demand D2 of hot water or cold water is increased and the demand D1 of electricity is decreased. Furthermore, when the operational method for the facility 5A is determined such that the evacuees are evacuated such that they are assigned to the areas R2 to R5 to stay therein, the demand D2 of hot water or cold water can be decreased but the demand D1 of electricity is increased. In addition, when the operational method for the facility 5A is determined such that the evacuees are evacuated to stay in one of the areas R2 to R5, the demand D2 of hot water or cold water can be decreased and the demand D1 of electricity can also be decreased. However, in this case, the above one area is crowded with the evacuees and the evacuees may thus feel uncomfortable. As described above, when the operational method for the facility 5A is determined, the operational methods for the electricity load installation 1 and the heat load installation 2 are also determined accordingly. As a result, the load of electricity and the load of heat are determined, and operation plans of the power source installation 3 and the heat source installation 4 can thus be created.

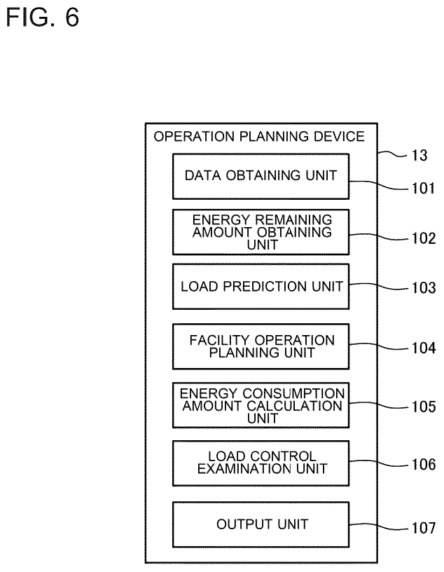

FIG. 6 is a configuration diagram illustrating a configuration of the operation planning device 13 according to Embodiment 1. As illustrated in FIG. 6, the operation planning device 13 includes a data obtaining unit 101, an energy remaining amount obtaining unit 102, a load prediction unit 103, an installation operation planning unit 104, an energy consumption amount calculation unit 105, a load control examination unit 106, and an output unit 107.

The data obtaining unit 101 obtains at least one of the registration data 6 that is held by the monitoring control device 11 in advance, the measurement data 7 collected from the sensors 10, the external data 8 obtained through communication with the outside, and the input data 9 input by, for example, the facility manager. It should be noted that the registration data 6 is stored in advance in the storage unit 12 of the monitoring control device 11. The measurement data 7 measured by the sensor 10 is transmitted from the sensor 10 to the data obtaining unit 101 through a wired or wireless communication. The external data 8 is downloaded from the content 21 on the Internet 20 by the data obtaining unit 101 via the Internet 20 and the communication device 16. The input data 9 is input to the smartphone 17 by, for example, the facility manager. The smartphone 17 transmits the input data 9 to the data obtaining unit 101 via the communication device 16.

Examples of the data 6 to 9 that are obtained by the data obtaining unit 101 will be explained. It should be noted that the following examples are merely examples and the data are not limited to those examples. In addition, each of the data 6 to 9 has only to include at least one data of the following examples.

The registration data 6 include data on architectural design, such as the number of buildings in the facility 5A, the total floor area of the facility 5A, intended uses of the facility 5A, the total floor area for each of intended uses of the facility 5A, the geographical location of the facility 5A, the size of a building wall and the structure of a building material of the facility 5A, the heat insulation property of the facility 5A, and the size and the structure of an opening, such as a window, provided in the facility 5A. The registration data 6 may further include data on installation design that includes data on facility specifications, such as the number of units in each of the electricity load installation 1, the heat load installation 2, the power source installation 3, and the heat source installation 4 that are installed in the facility 5A, the capability of each of those installations 1 to 4, the capacity of each of the installations 1 to 4, the efficiency of each of the installations 1 to 4, an operating restriction of each of the installations 1 to 4, a restriction on operation change rate of each of the installations 1 to 4, and a connection relationship between the installations 1 to 4.

The input data 9 includes data that is input into the smartphone 17 that the facility manager or user carries. The input data 9 may also include data obtained by a portable camera, a transportable sensor, or a transportable storage device that the facility manager or user carries. The input data 9 may include data that is visually confirmed and is input to the smartphone 17 by the facility manager or user. Furthermore, the input data may include data on questionnaire results collected via a portable device that the facility manager or user carries, Moreover, the input data 9 may include data on the result of determination by the facility manager or user.

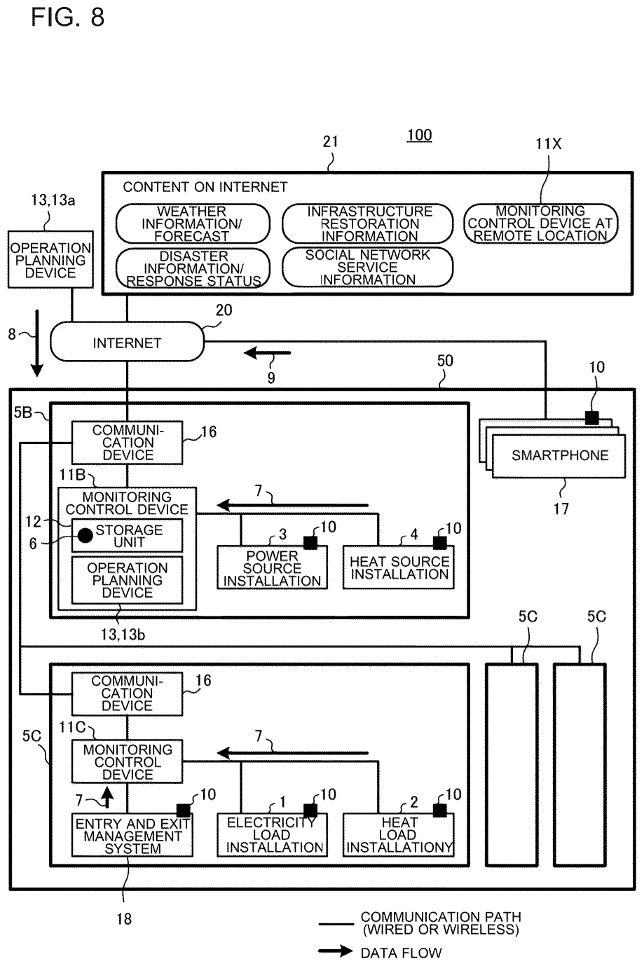

The measurement data 7 is data measured by each of the sensors 10. The measurement data 7 includes data on physical quantities that include, for example, the temperature, the humidity, the illuminance, the flow rate, and the pressure of the place at which the sensor 10 is installed in the facility 5A, and the electric power and the electric energy of the power source installation 3 or the electricity load installation 1. The measurement data 7 may further include data on operational statuses, such as a start/stop state, an operation mode, and abnormality, for each of the installations 1 to 4 installed in the facility 5A, which include the electricity load installation 1, the heat load installation 2, the power source installation 3, and the heat source installation 4. In addition, the measurement data 7 may include data on a pedestrian flow that includes, for example, the number of people who enter and exit the facility 5A, each of rooms in the facility 5A, or a region 50 (see FIG. 8) or personal data of the people.

The external data 8 includes at least one of the following information items that are delivered through the Internet 20; a weather observation value; a weather prediction value; disaster information; information on disaster response activities, information on restoration of infrastructure such as electricity and fuel, information on social network service, and information given to and received from the monitoring control device 11X that is installed at a remote location but operates in cooperation.

The energy remaining amount obtaining unit 102 obtains the remaining amount of energy that is available during the “energy sustainable target time.” The “energy sustainable target time” indicates a desired duration of the operations for the power source installation 3 and the heat source installation 4. The energy remaining amount obtaining unit 102 calculates the available remaining amount of energy based on, for example, the amount of fuel stored in advance in the facility 5A.

The load prediction unit 103 tentatively determines the operational method for the electricity load installation 1, that for the heat load installation 2, and that for the facility 5A based on the data obtained by the data obtaining unit 101. The load prediction unit 103 calculates an operation amount of ventilation by an air-conditioning apparatus or a ventilator (not illustrated), the operation amount of an air-conditioning apparatus, and the operation amounts of the electricity load installation 1 and the heat load installation 2, including the operation amounts of the electric lights 1a, based on a space or spaces where evacuees stay in the facility 5A, how the evacuees spend time, the number of the evacuees, weather information, and the heat insulation property of the facility 5A, and calculate a prediction value of the load of electricity and a prediction value of the load of heat. The prediction value of the load of electricity and the prediction value of the load of heat that are calculated by the load prediction unit 103 are a prediction value of the load of the electricity load installation 1 and a prediction value of the load of the heat load installation 2, respectively, during the “energy sustainable target time.”

The installation operation planning unit 104 creates, based on the prediction values calculated by the load prediction unit 103, operation plans of the power source installation 3 and the heat source installation 4 in order that the load of the electricity load installation 1 and the load of the heat load installation 2 be satisfied. That is, the installation operation planning unit 104 creates operation plans of the power source installation 3 and the heat source installation 4 in order that the demands indicated by the left bar in FIG. 4, (a) or FIG. 5, (a) be satisfied. As a method of creating operation plans by the installation operation planning unit 104, one of the following methods can be used, for example.
(1) A rule-based method in which an operation amount of the power source installation 3 and that of the heat source installation 4 are assigned in turns by following a predetermined rule in such a manner as to satisfy prediction values of the electricity load and the heat load.
(2) A method in which at first, initial values of operation amounts of the power source installation 3 and the heat source installation 4 are applied as appropriate, and calculation is then repeated to search for, according to algorism, operation amounts of the power source installation 3 and the heat source installation 4 that satisfy the loads.
(3) A method in which an optimization problem to determine operation amounts of the power source installation 3 and the heat source installation 4 such that the total value of the consumption amounts of energy of the power source installation 3 and the heat source installation 4 is minimized is formulated to find an optimal solution.

The energy consumption amount calculation unit 105 calculates energy consumption amounts in the power source installation 3 and the heat source installation 4, that is, consumption amounts of fuel therein, during the “energy sustainable target time”, based on the operation plans of the power source installation 3 and the heat source installation 4 that are created by the installation operation planning unit 104. The energy consumption amount is calculated for each of kinds of fuel.

The load control examination unit 106 examines a method of improving the ratio between the consumption amounts of electricity and heat in the electricity load installation 1 and the heat load installation 2 in such a manner as to reduce the energy consumption amounts calculated by the energy consumption amount calculation unit 105. Specifically, the communication device 16 examines at least one of the operational method for the electricity load installation 1, that for the heat load installation 2, and that for the facility 5A. The load control examination unit 106 first calculates a shortage amount of energy based on the energy consumption amounts calculated by the energy consumption amount calculation unit 105. More specifically, the load control examination unit 106 first obtains the remaining amount of energy that is obtained by the energy remaining amount obtaining unit 102 for each kind of fuel. Next, the load control examination unit 106 compares, for each kind of fuel, the energy remaining amount with the energy consumption amount calculated by the energy consumption amount calculation unit 105 to calculate the shortage amount. Then, the load control examination unit 106 determines whether an energy shortage occurs or not based on the calculated shortage amount. When an energy shortage occurs, the load control examination unit 106 changes the operational method for the electricity load installation 1, the heat load installation 2, or the facility 5A and transmits the changed manner of operation to the load prediction unit 103. By contrast, when an energy shortage does not occur, the load control examination unit 106 transmits the operational methods for the electricity load installation, the heat load installation, and the facility 5A at that moment to the output unit 107.

The output unit 107 outputs at least one of the operational method for the electricity load installation 1, that for the heat load installation 2, and that for the facility 5A that are examined by the load control examination unit 106. As a method of outputting the above at least one operational method, the output unit 107 displays it on a display of a computing device included in the monitoring control device 11 or transmits it to the smartphone 17 of the facility manager. Alternatively, the output unit 107 displays it on a display device (not illustrated) installed in the facility 5A or announces a voice message in the facility 5A to notify the facility manager and the evacuees that the operational method for the facility 5A is changed.

Hardware configurations of the monitoring control device 11 and the operation planning device 13 will be described. The monitoring control device 11 and the operation planning device 13 are processing circuits. Each of the processing circuits is dedicated hardware or a processor. The dedicated hardware is, for example, an application specific integrated circuit (ASIC) or a field programmable gate array (FPGA). The processor runs a program stored in a memory. The storage unit 12 is a memory. The memory is, for example, a non-volatile or volatile semiconductor memory, such as a random access memory (RAM), a read only memory (ROM), a flash memory, or an erasable programmable ROM (EPROM), or a disk, such as a magnetic disk, a flexible disk, or an optical disc.

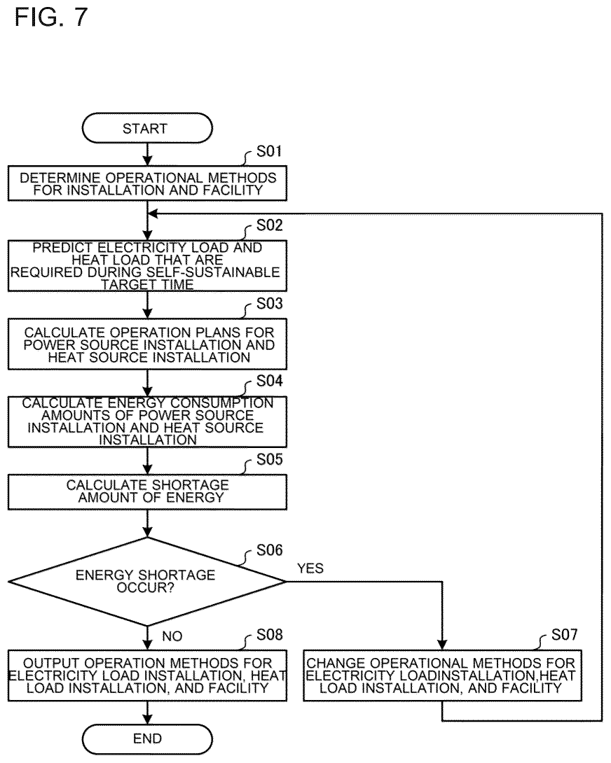

FIG. 7 is a flowchart indicating a flow of processes that are executed by the operation planning device 13 according to Embodiment 1 at the time of outputting the operational method for the electricity load installation 1, that for the heat load installation 2, and that for a facility 5A.

In step S01, the load prediction unit 103 determines the operational method for the electricity load installation 1, that for the heat load installation 2, and that for the facility 5A, using the registration data 6 held by the monitoring control device 11 and the data 7 to 9 obtained by the data obtaining unit 101. The operational method for the facility 5A refers to a space or spaces where evacuees stay, how the evacuees spend time, and the number of the evacuees. That is, as the operational method for the facility 5A, the load prediction unit 103 determines the number of evacuees to stay in each space (area) and determines a wakeup time and a bedtime for the evacuees. As a result, an area to be air-conditioned is determined, and it is therefore possible to how many individual split-type air-conditioning apparatuses 1b included in the electricity load installation 1 are to be operated or how many central heat source type air-conditioning apparatuses 2a included in the heat load installation 2 are to be operated. In addition, because an electric light 1a is used in a space (area) where evacuees stay, for a time period from the wakeup time to the bedtime, it is possible to determine how many electric lights 1a will be operated and how many hours they will be operated. Based on these determinations, the load prediction unit 103 determines the operational method for the electricity load installation 1 and that for the heat load installation 2.

Next, in step S02, the load prediction unit 103 calculates prediction values of a future electricity load and a heat load that are to be applied during the “energy sustainable target time”, based on the operational methods determined in step S01.

In step S03, the installation operation planning unit 104 calculates operation plans of the power source installation 3 and the heat source installation 4 such that the prediction values of the electricity load and the heat load calculated in step S02 are satisfied.

In step S04, the energy consumption amount calculation unit 105 calculates an energy consumption amount, that is, a consumption amount of a fuel, based on the operation plans of the power source installation and the heat source installation that are calculated in step S03. The energy consumption amount is calculated for each of kinds of fuel.

In step S05, the load control examination unit 106 calculates a shortage amount of energy based on the energy consumption amounts calculated in step S04. For each type of fuel, the load control examination unit 106 compares the remaining amount of the energy with the consumption amount of the energy and calculates the shortage amount of the energy.

In step S06, the load control examination unit 106 determines whether an energy shortage occurs or not based on the shortage amount of the energy that is calculated in step S05. When an energy shortage occurs, the processing proceeds to step S07. When an energy shortage does not occur, the processing proceeds to step S08.

In step S07, the load control examination unit 106 changes the operational method for the electricity load installation 1, that for the heat load installation 2, and, and that of the facility 5A to improve the heat-to-electricity ratio of load such that the “energy sustainable target time” can be achieved. Then, the operational methods are updated to reflect the change, and the process returns to step S02 and the processing is repeated.

On the other hand, in step S08, the output unit 107 outputs the operational method for the electricity load installation 1, that for the heat load installation 2, and that for the facility 5A that are those at that moment.

It should be noted that it is described above that the operational methods that are output from the load prediction unit 103 and the load control examination unit 106 are the operational method for the electricity load installation 1, that for the heat load installation 2 and that for the facility 5A, but the description is not limiting. The operational method that is output from the load prediction unit 103 and the load control examination unit 106 may be at least one of the operational method for the electricity load installation 1, that for the heat load installation 2, and that for the facility 5A. Similarly, the operational method that is output from the output unit 107 may be at least one of the operational method for the electricity load installation 1, that for the heat load installation 2, and that for the facility 5A.

As described above, in Embodiment 1, the monitoring control device 11 controls operations of the electricity load installation 1 and the heat load installation 2 according to the operational method that is output by the operation planning device 13. Alternatively, the monitoring control device 11 presents the operational method output by the operation planning device 13 to the facility manager, and controls operations of the electricity load installation 1 and the heat load installation 2 upon reception of a correction from the facility manager, as needed. In this case, the facility manager may input the contents of the correction directly to the computing device included in the monitoring control device 11 via an interface or may input the contents of the correction from the smartphone 17.

In Embodiment 1, the monitoring control device 11 creates operation plans for the power source installation and the heat source installation that are applied to improve the heat-to-electricity ratio of the load in such a manner as to achieve the energy sustainable target time, and the monitoring control device 22 then controls the load. As a result, it is possible to obtain a remarkable advantage in which supply of energy can be continued for a desired time period in the entire system utilizing energy such as electricity and heat and which cannot be obtained in an existing system.

Furthermore, in Embodiment 1, the monitoring control device 11 presents, to the facility manager, the operational method for the facility 5A that is output by the operation planning device 13. Alternatively, the monitoring control device 11 displays the operational method on the display device in the facility 5A or announces the operational method in the facility 5A. In such a manner, the monitoring control device 11 notifies the facility manager and the evacuees that the operational method for the facility 5A is determined or changed to call their attention to it.

According to Embodiment 1, the heat-to-electricity ratio is improved in order to achieve a continuous operation for the “energy sustainable target time” in which the self-sustained operation is desired to be continued. Then, because it is possible to obtain at least one of the operational method for the electricity load installation 1, that for the heat load installation 2, and that for the facility 5A, in which the heat-to-electricity is improved, the facility 5A in which needs for the continuous operation at the time of disaster are satisfied can be operated.

### Embodiment 2

The monitoring control device 11 and the operation planning device 13 according to Embodiment 2 can be applied not only to the facility 5A but also to the entire region 50 including multiple facilities 5B and 5C.

FIG. 8 is a configuration diagram illustrating configurations of a monitoring control device 11B and a monitoring control device 11C installed in a cogeneration system 100 according to Embodiment 2. In the example illustrated in FIG. 8, the multiple facilities 5B and 5C belong to the region 50. Although in the example of FIG. 8, one facility 5B and three facilities 5C are installed in the region 50, the example of FIG. 8 is illustrated merely as an example and illustration of the example of FIG. 8 is not limiting.

In the facility 5B and the facilities 5C, the electricity load installation 1, the heat load installation 2, the power source installation 3, and the heat source installation 4 are installed. In the example of FIG. 8, the monitoring control device 11B including the operation planning device 13 and the storage unit 12 is installed in the facility 5B that controls the entire region 50. In the facility 5B, the power source installation 3, the heat source installation 4, the sensors 10, and the communication device 16 are further installed. The configurations and operations of the operation planning device 13, the storage unit 12, the power source installation 3, the heat source installation 4, the sensors 10, and the communication device 16 are the same as those in Embodiment 1, and their descriptions will thus be omitted. However, in Embodiment 2, the operation planning device 13 also determines the operational methods for the facilities 5C, and the operational methods for the electricity load locations 1 and the heat load locations 2 that are installed in the facilities 5C. On this point, Embodiment 2 is different from Embodiment 1.

The three facilities 5C are different from the facility 5B in configuration. Because the three facilities 5C have the same configuration, in FIG. 8, one of them is illustrated and illustration of the others is omitted. In each of the facilities 5C, the monitoring control device 11C, the entry and exit management system 18, the electricity load installation 1, the heat load installation 2, sensors 10, and the communication device 16 are installed. The monitoring control device 11C collects information on each of installations in the facility 5C in which the monitor control device 11C is installed, and provides the information to the monitoring control device 11B installed in the facility 5B.

That is, the monitoring control device 11C installed in the facility 5C does not include the operation planning device 13. Therefore, the operational methods for the electricity load installation 1 and the heat load installation 2 and the operational methods for the facilities 5C are determined by the operation planning device 13 of the facility 5B. The monitoring control device 11C installed in the facility 5C operates the electricity load installation 1, the heat load installation 2, and the facility 5C according to the operational methods determined by the operation planning device 13 of the facility 5B.

In the example of FIG. 8, the power source installation 3, the heat source installation 4, and the monitoring control device 11B are installed in the same facility 5B, but this configuration is not important. The important thing is that the power source installation 3 and the heat source installation 4 are installed at a place where the power source installation 3 and the heat source installation 4 can supply energy to the region 50 at the time of disaster. Thus, it is not necessary to limit the installation locations of the power source installation 3 and the heat source installation 4 to specific ones as long as the functions of the monitoring control device 11B are provided in such a manner as to enable the region 50 be monitored and controlled at the time of disaster. In addition, the functions of the monitoring control device 11B may be provided, for example, on the cloud via the Internet 20.

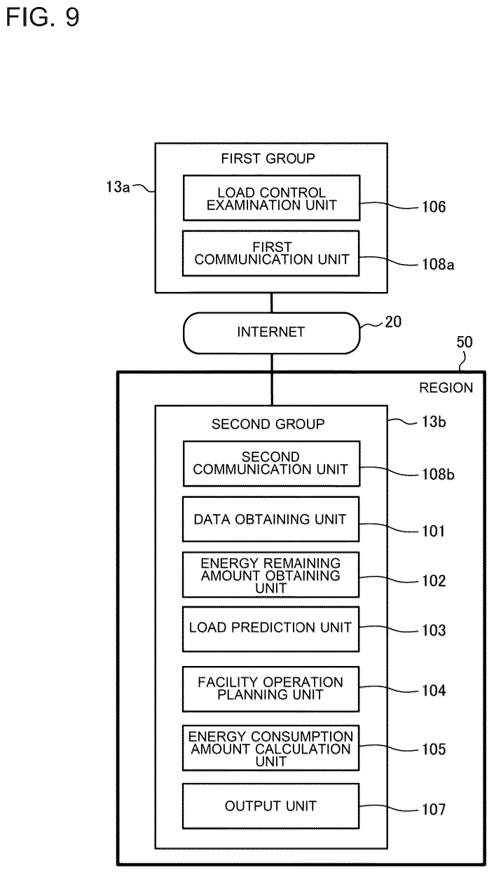

FIG. 9 is a configuration diagram illustrating a configuration of the operation planning device 13 according to Embodiment 2. As can be seen from comparison between FIG. 6 and FIG. 9, referring to FIG. 9, of the functions of the operation planning device 13 as illustrated in FIG. 6, the load control examination unit 106 is provided outside the region 50 via the Internet 20. That is, in the example of FIG. 9, the functions of the operation planning device 13 are classified into a first group 13a and a second group 13b. The first group 13a includes the load control examination unit 106. The second group 13b includes the data obtaining unit 101, the energy remaining amount obtaining unit 102, the load prediction unit 103, the installation operation planning unit 104, the energy consumption amount calculation unit 105, and the output unit 107. In addition, the first group 13a and the second group 13b include a first communication unit 108a and a second communication unit 108b, respectively, to communicate with each other. Thus, communication between the first group 13a and the second group 13b is performed via the first communication unit 108a and the second communication unit 108b.

It should be noted that although in the example of FIG. 9, only the load control examination unit 106 belongs to the first group 13a and is provided outside the region 50, the configuration is not limited to the configuration illustrated in FIG. 9. That is, at least one of the data obtaining unit 101, the energy remaining amount obtaining unit 102, the load prediction unit 103, the installation operation planning unit 104, the energy consumption amount calculation unit 105, and the output unit 107 may be made to belong to the first group 13a and provided outside the region 50, as well as the load control examination unit 106.

In such a manner, the data obtaining unit 101, the energy remaining amount obtaining unit 102, the load prediction unit 103, the installation operation planning unit 104, the energy consumption amount calculation unit 105, the load control examination unit 106, and the output unit 107 that are included in the operation planning device 13 may be classified into the first group 13a and the second group 13b in an arbitrary combination. Furthermore, the number of groups may be an arbitrary number greater than one. That is, at least one of the units 101 to 107 included in the operation planning device 13 may belong to the first group 13a, and at least one of the remaining units may belong to the second group 13b. Then, the further remaining units may belong to a third group, a fourth group, or any other group.

In Embodiment 1, the operation planning device 13 outputs the operational methods for the electricity load installation 1, the heat load installation 2, and the facility 5A (see step S08 in FIG. 7). In Embodiment 2, the operation planning device 13 is configured to output the operational methods for the facilities 5B and 5C or the operational method for the region 50, instead of the operational method for the facility 5A.

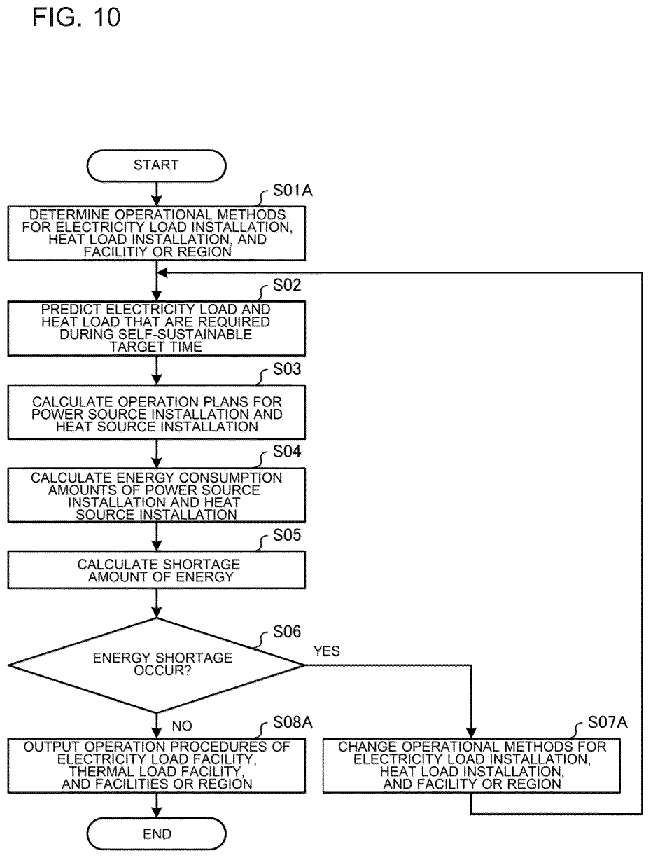

FIG. 10 is a flowchart indicating a flow of processes in the case where the operation planning device 13 according to Embodiment 2 outputs the operational method for the electricity load installation 1, that for the heat load installation 2, and those for the facilities 5B and 5C or that for the region 50.

As can be seen from comparison between FIG. 7 and FIG. 10, referring to FIG. 10, step S01A, step S07A, and step S08A are provided in place of step S01, step S07, and step S08 of FIG. 7. The other steps are the same in operation as those in FIG. 7, and they will be denoted by the same reference signs and their explanations will thus be omitted.

In step S01A in FIG. 10, the load prediction unit 103 determines the operational method for the electricity load installation 1, that for the heat load installation 2, and those for the facilities 5B and 5C or that for the region 50 by using the registration data 6 held by the monitoring control device 11 and the data 7 to 9 collected by the data obtaining unit 101.

In step S07A of FIG. 10, the load control examination unit 106 changes the operational method for the electricity load installation 1, that for the heat load installation 2, and those for the facilities 5B and 5C or that for the region 50 so that the heat-to-electricity ratio is improved to achieve the “energy sustainable target time”. Then, the processing returns to step S02 to repeat the process thereof.

In step S08A of FIG. 10, the output unit 107 outputs at least one of the operational method for the electricity load installation 1, that for the heat load installation 2, and those for the facilities 5B and 5C or that for the region 50 that are the operational methods thereof at that moment.

As described above, according to Embodiment 2, for the region 50, it is possible to obtain the operational method in which the heat-to-electricity ratio is improved to achieve the continuous operation for the “energy sustainable target time” during which self-sustained operation is desired to be continued. It should be noted that the above operational method is not limited to the operational method for the region 50, but may be at least one of, for example, the operational method for the electricity load installation 1, that for the heat load installation 2, and those for the facilities 5B and 5C or that for the region 50. As a result, the facilities 5B and 5C and the region 50 can be operated in such a manner as to satisfy the needs for the continuous operation at the time of disaster.

### Embodiment 3

The operational methods described regarding Embodiments 1 and 2 may be obtained as an optimization problem to minimize an evaluation value by evaluation using a predetermined evaluation function. This case will be described as follows regarding Embodiment 3. The following description is made by referring to by way of example the case where Embodiment 3 is applied to the configuration of Embodiment 2 as illustrated in FIG. 8.

An evaluation function that creates an index that quantifies how the facilities 5B and 5C or the region 50 are or is affected by change of the operational method for the electricity load installation 1, that for the heat load installation 2, and those for the facilities 5B and 5C or that for the region 50 is given as an example of the evaluation function. Specifically, when the operation of an air-conditioning apparatus, such as the individual split-type air-conditioning apparatus 1b or the central heat source type air-conditioning apparatus 2a, is limited, a thermal environment in an associated room is deteriorated. In summer, the room temperature and humidity increase and the environment comes close to a hot environment. In winter, the room temperature decreases and the environment comes close to a cold environment. Such an effect index indicating a thermal comfort can be used as an index of the evaluation function. In such a manner, the effect index quantifies the degree of an effect.

Not only the thermal comfort but also a light-environment comfort, the ratio of time during which an installation can be used to the “energy sustainable target time”, or measurement data 7 obtained by the sensor 10 may be used as the effect index.

Alternatively, in the case where the manager of the facility 5B or 5C creates a contract with the owner or user of the facility 5B or 5C to pay money as a penalty, the amount of money paid as the penalty may be used as an index of the evaluation function. For example, when the operational methods for the electricity load installation 1, the heat load installation 2, and the facilities 5B and 5C or the region 50 are changed, it has some effect. Suppose the manager of an installation creates a contract with the owner or user of the installation to pay money as a penalty depending on the scale of the effect. In such a case, the amount of money paid as the penalty may be used as an index of the evaluation function.

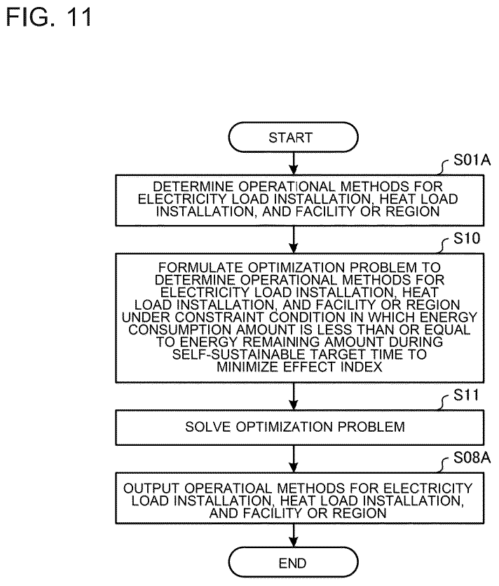

FIG. 11 is a flowchart illustrating a flow of processes in the case where the operation planning device 13 according to Embodiment 3 outputs the operational method for the electricity load installation 1, that for the heat load installation 2, and those for the facilities 5B and 5C or that for the region 50.

As in FIG. 10, in step S01A, the load prediction unit 103 tentatively determines the operational method for the electricity load installation 1, that for the heat load installation 2, and those for the facilities 5B and 5C or that for the region 50 by using the registration data 6 held by the monitoring control device 11 and the data 7 to 9 collected by the data obtaining unit 101. A this time, the load prediction unit 103 determines, for example, the operational method for the electricity load installation 1 and that for the heat load installation 2 after determining the operational methods for the facilities 5B and 5C or that for the region 50, as described above.

Next, in step S10, the load control examination unit 106 formulates an optimization problem to minimize an effect index based on the operational method determined in step S01A. Alternatively, in the case where the amount of money paid as penalty is used in the evaluation function, the load control examination unit 106 formulates an optimization problem to minimize the amount of money paid as penalty, instead of the effect index.

The optimization problem has a constraint condition in which the energy consumption amount is less than or equal to the energy remaining amount when the “energy sustainable target time” elapses and the result of the optimization ensures that the continuous operation can be achieved during the “energy sustainable target time.”

Next, in step S11, the load control examination unit 106 solves the optimization problem formulized in step S10. As the operational method for the electricity load installation 1, that for the heat load installation 2, and those for the facilities 5B and 5C or that of the region 50, in each of which the energy consumption amount is less than or equal to the energy remaining amount when the “energy sustainable target time” elapses, innumerable optional methods are present. However, with the optimization problem formulized in step S10, a point where the effect index is minimized is determined, and the operational method for the electricity load installation 1, that for the heat load installation 2, and those for the facilities 5B and 5C or that for the region 50 are output as optimized operational methods.

According to Embodiment 3, an optimized operational method can be obtained, from the viewpoint of the index given as an evaluation function, from among the operational methods in which the heat-to-electricity ratio is improved to achieve the continuous operation during the “energy sustainable target time” in which the self-sustained operation is desired to be continued. The optimized operational method is at least one of the operational method for the electricity load installation 1, that for the heat load installation 2, and, and those for the facilities 5B and 5C or that for the region 50. With this technique, the operational methods for the facilities 5B and 5C and the region 50 that satisfy needs for the continuous operation at the time of disaster can be applied.

### Embodiment 4

Multiple energy supply target times each having a shorter time length than that of the “energy sustainable target time” described regarding Embodiments 1 to 3 may be calculated, and an optimal solution may be output for each of those energy supply target times. This case will be described below regarding Embodiment 4. The following description is made by referring to by way of example the case where Embodiment 4 is applied to the configuration of Embodiment 2 as illustrated in FIG. 8.

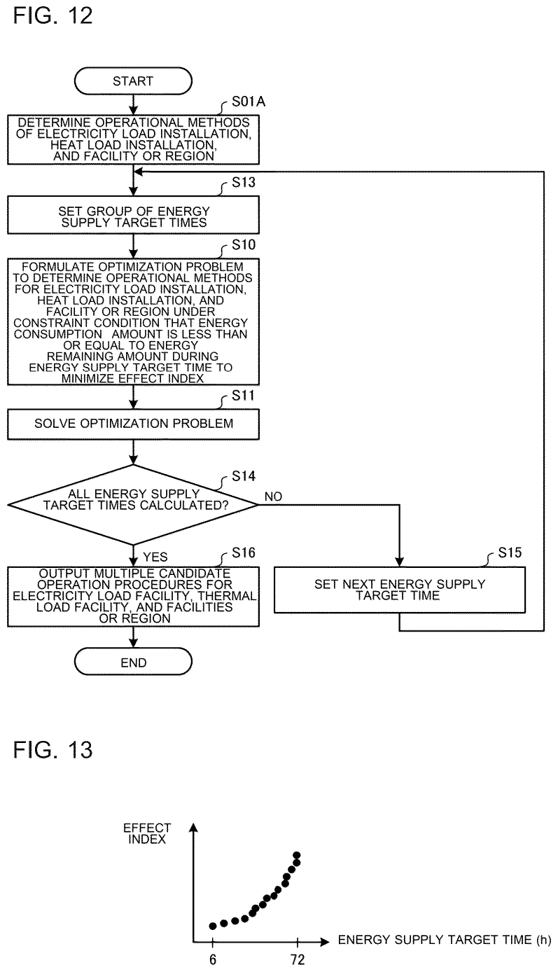

FIG. 12 is a flowchart indicating a flow of processes in the case where the operation planning device 13 according to Embodiment 4 outputs the operational method for the electricity load installation 1, that for the heat load installation 2, and those for the facilities 5B and 5C or that for the region 50. In FIG. 12, steps S13, S14, and S15 are added and step S16 is provided in place of step S08A. In this regard, FIG. 12 is different from FIG. 11.

Step S13 is provided between step S01A and step S10. Step S14 is provided between step S11 and step S16. Step S15 is a step to which the processing proceeds when “NO” is determined in step S14. Step S16 is a step to which the processing proceeds when “YES” is determined in step S14.

The other steps are the same as those in FIG. 11 in operation, and they will thus be denoted by the same reference signs and their explanations will be omitted.

In step S13 of FIG. 12, the load control examination unit 106 sets a group of energy supply target times. In this case, the group of energy supply target times are set such that each of the energy supply target times is shorter than or equal to the “energy sustainable target time”. For example, when the “energy sustainable target time” is 72 hours, the energy supply target times may be set to 72 hours, 66 hours, 60 hours, . . . and 6 hours; that is, the energy supply target time may be set in decrements of 6 hours. It should be noted that the energy supply target times do not need to be set in decrements of a constant time length. That is, the energy supply target times can be set in decrements of arbitrary irregular time lengths; an arbitrary number of energy supply target times can be set; and the energy supply target times can be set to arbitrary times.

In step S14, the load control examination unit 106 determines whether or not processes of steps S10 and S11 are executed for all the energy supply target time periods. If an energy supply target time period for which the above processes are not executed is present, the processing proceeds to step S15. If such an energy supply target time is not present, the processing proceeds to step S16.

In step S15, the load control examination unit 106 sets a next energy supply target time, and the processing then returns to step S13 to solve the optimization problem again.

In step S16, the output unit 107 outputs a plurality of possible operational methods for the electricity load installation 1, the heat load installation 2, and the facilities 5B and 5C or the region 50.

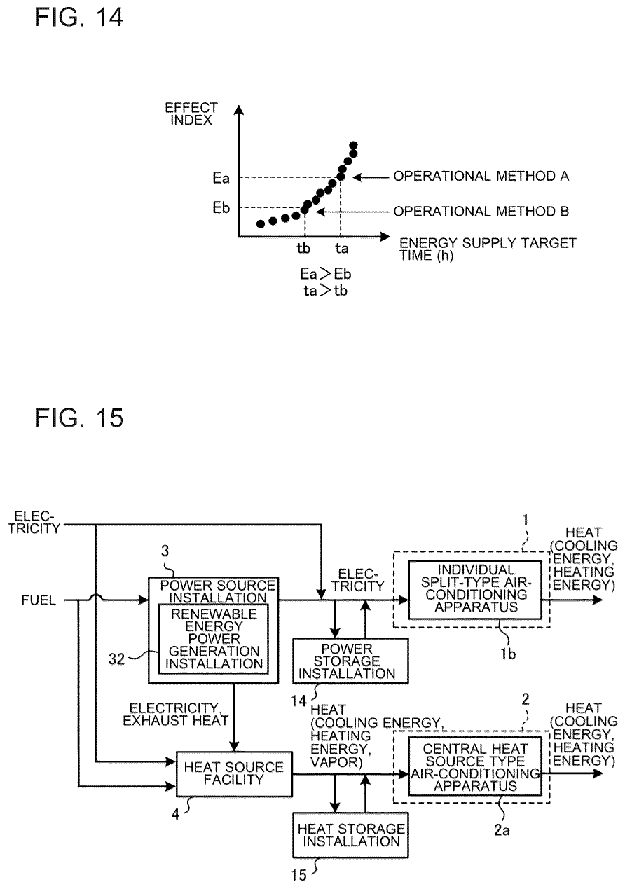

FIG. 13 is a graph in which effect indexes for the results of optimization with respect to multiple energy supply target times in the operation planning device 13 according to Embodiment 4 are plotted. In FIG. 13, the horizontal axis represents the energy supply target time and the vertical axis represents the effect index. In FIG. 13, values for the energy supply target time and the effect index are plotted on a plane representing a relationship between the energy supply target time and the effect index. The plots each correspond to an associated one of the energy supply target times, which are set as 72 hours, 66 hours, 60 hours . . . and 6 hours. In addition, the plots are each associated with a corresponding one of the operational method for the electricity load installation 1, that for the heat load installation 2, and, and those for the facilities 5B and 5C or that for the region 50. When in each of the energy supply target times, an associated operational method is implemented, the effect index and the continuous operation for the energy supply target time that are associated with a corresponding plot of the graph are expected to be realized. The operation planning device 13 may present the results of optimization as a graph as indicated in FIG. 13 to the facility manager, and enable the manager to select any of the operational methods as an operational method to implemented. It will be described with reference to FIG. 14 how the facility manager selects the operational method.

FIG. 14 is a diagram illustrating the case where the operational method A and the operational method B of multiple operational methods in the graph of FIG. 13 are compared with each other. In FIG. 14, Ea is the effect index for the operational method A and ta is the energy supply duration; and Eb is the effect index for the operational method B and tb is the energy supply duration. In this case, a relationship between the effect indexes Ea and Eb is established to satisfy Ea>Eb. In addition, a relationship between the energy supply durations ta and tb is established to satisfy ta>tb. As can be seen from this, in the operational method A, the energy supply duration is long but the effect index is large. By contrast, in the operational method B, the energy supply duration is short but the effect index can be made small. The facility manager can determine how the operational methods for the installations and facilities are set while checking a trade-off between the effect index and the energy supply duration. At the time of disaster, it is expected that effect indexes vary and conditions change from moment to moment. According to Embodiment 4, however, even under such a condition, the facility manager can determine how the operational method for the electricity load installation 1, that for the heat load installation 2, and those for the facilities 5B and 5C or that for the region 50 are set, with the support of the monitoring control device 11.

According to Embodiment 4, the facility manager can select an operational method for improving the heat-to-electricity ratio, while checking a tradeoff between the effect index given as the evaluation function and the energy supply duration. That is, the facility manager can select the operational method for the electricity load installation 1, that for the heat load installation 2, those for the facilities 5B and 5C or that for the region 50, while taking the tradeoff into consideration. As a result, the operations of the facilities 5B and 5C can be changed flexibly based on the situation of the disaster.

### Embodiment 5

The facilities to be managed by the monitoring control device 11 described regarding Embodiments 1 to 4 may further include a power storage installation, a heat storage installation, and a renewable energy power generation installation.

FIG. 15 illustrates a connection relationship between the electricity load installation 1, the heat load installation 2, the power source installation 3, the heat source installation 4, a power storage installation 14, and a heat storage installation 15 in the cogeneration system 100 according to Embodiment 5.

As illustrated in FIG. 15, the power storage installation 14 is connected between the power source installation 3 and the electricity load installation 1. The power storage installation 14 stores an electricity energy and outputs it as required. The power storage installation 14 stores in advance electricity from an external power source (not illustrated) or electricity from the power source installation 3 under normal conditions. In addition, the power storage installation 14 stores electricity that is not used immediately, of electricity that is generated after occurrence of a disaster. The power storage installation 14 includes, for example, a storage battery. At the time of disaster, the power storage installation 14 discharges stored electricity as needed to contribute to meeting the demand of electricity in the electricity load installation 1.

As illustrated in FIG. 15, the heat storage installation 15 is connected between the heat source installation 4 and the heat load installation 2. The heat storage installation 15 stores a heat energy and outputs it as required. The heat storage installation 15 stores heat in advance under normal conditions. In addition, the heat storage installation 15 stores exhaust heat that is not used immediately, of exhaust heat that is generated after occurrence of a disaster. The heat storage installation 15 includes, for example, a storage tank, a heat storage tank, a hot water tap, etc. At the time of disaster, the heat storage installation 15 discharges stored heat as needed to contribute to meeting the demand of heat in the heat load installation 2.

In Embodiment 5, the power source installation 3 includes a renewable energy power generation installation 32. The configuration and operation of the power source installation 3 itself are the same as those of the power source installation 3 as described regarding Embodiments 1 to 4. The renewable energy power generation installation 32 generates electricity, using a renewable energy. As examples of the renewable energy, solar light, wind power, water power, and a geothermal heat are present. The renewable energy power generation installation 32 is, for example, a solar panel for performing a solar power generation, a wind power generator for performing a wind power generation, or a similar device. The amount of power generation in the renewable energy power generation installation 32 depends on the weather conditions, and thus varies.

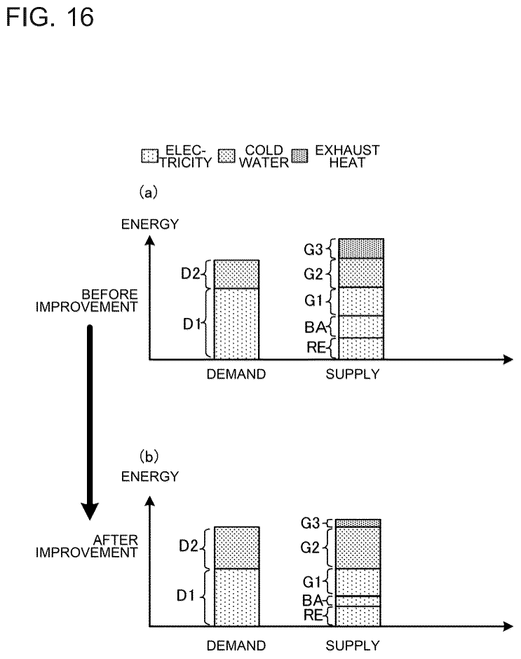

FIG. 16 is a diagram illustrating an example in which the energy sustainable target time is extended by reduction of an energy usage amount that is achieved by changing the heat-to-electricity ratio in the cogeneration system 100 according to Embodiment 5.

As indicated in the left bar of FIG. 16, (a), before the improvement, a demand D1 of electricity and a demand D2 of cold water are present. As indicated in the right bar of FIG. 16, (a), the demand D1 of electricity is met by an electricity denoted by G1 that is generated by fuel in the power source installation 3, an electricity denoted by BA that is discharged from the power storage installation 14, and an electricity denoted by RE that is generated by the renewable energy power generation installation 32. The demand D2 of cold water is met by conversion of an exhaust heat G2 that is generated with the power generation of the power source installation 3 into cold water via an exhaust-heat supply type absorption refrigerating machine included in the heat source installation 4. Of exhaust heat that is generated with the power generation of the power source installation 3, exhaust heat G3 that is not used in the generation of cold water is not necessary and is thus discharged.

At the time of disaster, because the consumption of fuel needs to be reduced as much as possible, the amount of power generation by the renewable energy power generation installation 32 needs to be increased as much as possible. However, because the amount of power generated with a renewable energy varies due to the effect of a weather condition, in some cases, the amount of power generation suddenly decreases. Under such a condition, it is possible to operate, for example, the electricity load installation 1 continuously without occurrence of a failure therein or a power outage by discharging electricity from the power storage installation 14 to offset the variation of the renewal energy. Therefore, it is necessary to keep electricity as much as possible in the power storage installation 14 so that electricity can be received as needed.

Thus, as illustrated in FIG. 16, (b), the heat-to-electricity ratio is improved such that the demand D1 of electricity is decreased and the demand D2 of cold water is increased, as compared with that prior to the improvement. The decreased amount of the demand D1 of electricity is allocated for reduction of the amount of electricity discharged from the power storage installation 14. Thus, the power storage installation 14 can keep the remaining amount of electricity so that electricity can be received as needed.

Furthermore, an increased amount of the demand D2 of cold water is satisfied by conversion of part of the exhaust heat G3 to be discharged into cold water. As described above, as long as the increased amount of the demand D2 of cold water can be covered by the exhaust heat G3 to be discharged, the consumption amount of a fuel in each of the power source installation 3 and the heat source installation 4 is not increased.

As described above, in Embodiment 5, the heat-to-electricity ratio is improved by utilizing the exhaust heat G3 that is discharged in the related art, such that the remaining amount of charge in the power storage installation 14 is kept as much as possible. As a result, it is possible to provide a system that satisfies the demands and copes with a sudden change in a renewable energy, while keeping the remaining amount of charge in the power storage installation 14.

In the above configuration of Embodiment 5, the operational method for the electricity load installation 1, that for the heat load installation 2, and those for the facilities 5B and 5C or that for the region 50 are applied in order to improve the heat-to-electricity ratio, and the power storage installation 14 and the heat storage installation 15 can thus be operated in such a manner as to maximize the use of a renewable energy. Therefore, the operations for the facilities 5B and 5C or the region 50 can be changed such that a renewable energy is effectively utilized at the time of disaster.

### Embodiment 6

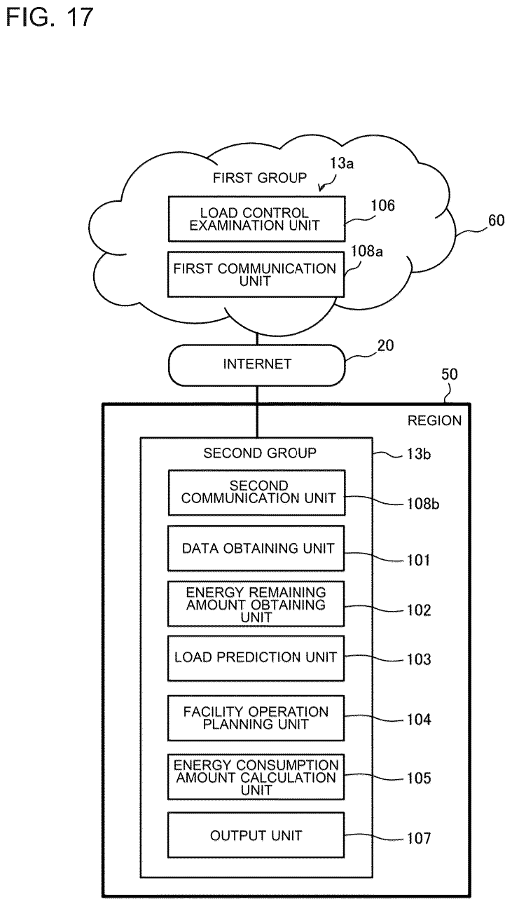

FIG. 17 is a configuration diagram illustrating a configuration of the operation planning device 13 according to Embodiment 6. As can be seen from comparison between FIG. 6 and FIG. 17, of the functions of the operation planning device 13 as illustrated in FIG. 6, the load control examination unit 106 is provided on a cloud server 60 in FIG. 17.

That is, in the example illustrated in FIG. 17, the functions of the operation planning device 13 are classified into a first group 13a and a second group 13b as in Embodiment 2. The first group 13a includes the load control examination unit 106. The second group 13b includes the data obtaining unit 101, the energy remaining amount obtaining unit 102, the load prediction unit 103, the installation operation planning unit 104, the energy consumption amount calculation unit 105, and the output unit 107. In addition, the first group 13a and the second group 13b include a first communication unit 108a and a second communication unit 108b, respectively, to communicate with each other. Thus, communication between the first group 13a and the second group 13b is performed via the first communication unit 108a and the second communication unit 108b.

It should be noted that although in the example of FIG. 17, only the load control examination unit 106 belongs to the first group 13a and is provided on the cloud server 60, this illustration of the figure is not limiting. That is, at least one of the data obtaining unit 101, the energy remaining amount obtaining unit 102, the load prediction unit 103, the installation operation planning unit 104, the energy consumption amount calculation unit 105, and the output unit 107 may be made to belong to, together with the load control examination unit 106, the first group 13a, and be provided on the cloud server 60. In addition, the second group 13b is provided in a server (not illustrated) installed in the region 50. The server may be provided in the facility 5B or facility 5C as illustrated in FIG. 8. The server may be provided outside the region 50. In either case, the server, the cloud server 60, and the smartphone 17 are connected via the Internet 20.

As described above, the data obtaining unit 101, the energy remaining amount obtaining unit 102, the load prediction unit 103, the installation operation planning unit 104, the energy consumption amount calculation unit 105, the load control examination unit 106, and the output unit 107 that are included in the operation planning device 13 may be classified into the first group 13a and the second group 13b in an arbitrary combination. Furthermore, the number of groups may be any number greater than two. That is, at least one of the units 101 to 107 may belong to the first group 13a, and at least one of the remaining units may belong to the second group 13b. Then, the further remaining units may belong to a third group, a fourth group, and so on.

### REFERENCE SIGNS LIST

1: electricity load installation, 1a: electric light, 1b: individual split-type air-conditioning apparatus, 2: heat load installation, 2a: central heat source type air-conditioning apparatus, 2b: water heater, 3: power source installation, 4: heat source installation, 4A: heat source installation, 5A: facility, 5B: facility, 5C: facility, 6: registration data, 7: measurement data, 8: external data, 9: input data, 10: sensor, 11: monitoring control device, 11B: monitoring control device, 11C: monitoring control device, 11X: monitoring control device, 12: storage unit, 13: operation planning device, 13a: first group, 13b: second group, 14: power storage installation, 15: heat storage installation, 16: communication device, 17: smartphone, 18: entry and exit management system, 20: Internet, 21: content, 30: power and heat source installation, 32: renewable energy power generation installation, 50: region, 60: cloud server, 100: cogeneration system, 101: data obtaining unit, 102: energy remaining amount obtaining unit, 103: load prediction unit, 104: installation operation planning unit, 105: energy consumption amount calculation unit, 106: load control examination unit, 107: output unit, 108a: first communication unit, 108b: second communication unit

1. An operation planning device that creates operation plans for a power source installation and a heat source installation that operate an electricity load installation and a heat load installation, respectively, which are installed in a facility or a region, the operation planning device comprising:
a data obtaining unit configured to obtain at least one of registration data registered in advance as data regarding the facility or the region, input data input from an outside, measurement data measured by a sensor installed in the facility or the region, and external data obtained from the outside via communication;
an energy remaining amount obtaining unit configured to obtain a remaining amount of an available energy that is allowed to be used in the facility or the region during an energy sustainable target time indicating a desired duration of continuous operations of the power source installation and the heat source installation;
a load prediction unit configured to tentatively determine an operational method for the electricity load installation, an operational method for the heat load installation, and an operational method for the facility or the region based on the data obtained by the data obtaining unit, and predict a load of the electricity load installation and a load of the heat load installation that are required during the energy sustainable target time, based on the operational methods; and
an installation operation planning unit configured to create, based on the load of the electricity load installation and the load of the heat load installation that are predicted by the load prediction unit, operation plans for the power source installation and the heat source installation that are feasible with the remaining amount of the available energy that is obtained by the energy remaining amount obtaining unit.

2. The operation planning device of claim 1, further comprising:
an energy consumption amount calculation unit configured to calculate amounts of energies that are consumed by the power source installation and the heat source installation during the energy sustainable target time, based on the operation plans created by the installation operation planning unit; and
a load control examination unit configured to change a ratio between electricity and heat that are consumed by the electricity load installation and the heat load installation to reduce the amounts of the consumed energies that are calculated by the energy consumption amount calculation unit, and update, based on the ratio, at least one of the operational method for the electricity load installation, the operational method for the heat load installation, and the operational method for the facility or the region.

3. The operation planning device of claim 2, further comprising:
an output unit configured to output at least one of the operational method for the electricity load installation, the operational method for the heat load installation, and the operational method for the facility or the region that are output by the load prediction unit or the load control examination unit.

4. The operation planning device of claim 1, which is configured to create operation plans for the power source installation and the heat source installation that operate the electricity load installation and the heat load installation, respectively, which are installed in the facility or the region, for a predetermined energy sustainable target time at time of a disaster at which a supply of an energy to the facility or the region from the outside is limited.

5. The operation planning device of claim 2, wherein the load control examination unit is configured to evaluate, using a predetermined evaluation function, at least one of the operational method for the electricity load installation, the operational method for the heat load installation, and the operational method for the facility or the region.

6. The operation planning device of claim 5, wherein the load control examination unit is configured to
formulate an optimization problem to minimize an index of the evaluation of the evaluation function under a constraint condition in which the amounts of the consumed energies that are calculated by the energy consumption amount calculation unit are less than or equal to the energy remaining amounts obtained by the energy remaining amount obtaining unit, during the energy sustainable target time, and
output at least one of the operational method for the electricity load installation, the operational method for the heat load installation, and the operational method for the facility or the region, the at least one operational method being determined according to a value of the index.

7. The operation planning device of claim 5, wherein the index of evaluation in the evaluation function is an effect index that quantifies a degree of an effect of the update of the at least one of the operational method for the electricity load installation, the operational method for the heat load installation, and the operational method for the facility or the region.

8. The operation planning device of claim 5, wherein when the update of the at least one of the operational method for the electricity load installation, the operational method for the heat load installation, and the operational method for the facility or the region has an effect on a user of at least one of the electricity load installation, the heat load installation, and the facility or the region, in a case where an facility manager has a contract with the user to pay money as a penalty according to a level of the effect, the index of evaluation in the evaluation function is an amount of payment of the money paid as the penalty.

9. The operation planning device of claim 7, wherein
a plurality of energy supply target times each having a shorter time length than the energy sustainable target time are set, and
the load control examination unit is configured to
plot a value for both an energy supply target time and an effect index, which corresponds to at least one of the operational method for the electricity load installation, the operational method for the heat load installation, and the operational method for the facility or the region, on a plane representing a relationship between the energy supply target time and the effect index, with one axis indicating the energy supply target time and an other axis indicating the effect index, and
plot at least two values on the plane.

10. The operation planning device of claim 8, wherein
a plurality of energy supply target times each having a shorter time length than the energy sustainable target time are set, and
the load control examination unit is configured to plot a value for both an energy supply target time and the amount of the money paid as the penalty, which corresponds to at least one of the operational method for the electricity load installation, the operational method for the heat load installation, and the operational method for the facility or the region, on a plane representing a relationship between the energy supply target time and the amount of the money paid as the penalty, with one axis indicating the energy supply target and an other axis indicating the amount of the money paid as penalty, and
plot at least two values on the plane.

11. The operation planning device of claim 1, wherein the power source installation and the heat source installation are combined and provided as a power and heat source installation configured to supply both electricity and heat.

12. The operation planning device of claim 1, wherein the facility or the region includes at least one of
a power storage installation provided between the power source installation and the electricity load installation and having a function of storing and discharging an electricity energy, and
a heat storage installation provided between the heat source installation and the heat load installation and having a function of storing and discharging a heat energy.

13. The operation planning device of claim 1, wherein
the registration data incudes at least one of architectural design data and installation design data, the architectural design data including the number of buildings in the facility, a total floor area of the facility, a total area of floors in the facility that are provided for each of different uses, a geographical location of the facility, a size of each of walls and a structure of a building material of the facility, and a size and a structure of an opening in the facility,
the installation design data including data on installation specifications including the number of installations installed in the facility, a capability of each of the installations, a capacity of the installation, an efficiency of the installation, an operating restriction of the installation, a restriction on an operation change rate of the installation, and a connection relationship between the installations,
the input data includes at least one of data obtained by a portable camera, a transportable sensor, and/or a recording device, data that is visually confirmed, data on a questionnaire result collected via a portable device, and data on a result determined by a person,
the measurement data includes at least one of data on a physical quantity including a temperature, a humidity, a illuminance, a flow rate, a pressure, electricity, and the amount of electricity of the facility, data on an operational status including a start/stop state, an operation mode, and an abnormality of each of installations in the facility, and data on a pedestrian flow including the number of people who enters and exits the facility, each of rooms in the facility or the region, or personal data of the people, and
external data includes at least one of information distributed through the Internet including a weather observation value, a weather prediction value, disaster information, information on disaster response activities, information on restoration of an electricity infrastructure and a fuel infrastructure, information on a social network service, and information given to and from a monitoring control device that is installed at a remote location and operates in cooperation.

14. A cogeneration system that creates operation plans for a power source installation and a heat source installation that operate an electricity load installation and a heat load installation, respectively, which are installed in a facility or a region, the cogeneration system comprising:
a data obtaining unit configured to obtain at least one of registration data registered in advance as data regarding the facility or the region, input data input from an outside, measurement data measured by a sensor installed in the facility or the region, and external data obtained from the outside via communication;
an energy remaining amount obtaining unit configured to obtain a remaining amount of an available energy that is allowed to be used in the facility or the region during an energy sustainable target time indicating a desired duration of continuous operations of the power source installation and the heat source installation;
a load prediction unit configured to tentatively determine the operational method for the electricity load installation, the operational method for the heat load installation, and the operational method for the facility or the region based on the data obtained by the data obtaining unit, and predict a load of the electricity load installation and a load of the heat load installation that are required during the energy sustainable target time, based on the operational methods;
an installation operation planning unit configured to create, based on the load of the electricity load installation and the load of the heat load installation that are predicted by the load prediction unit, operation plans for the power source installation and the heat source installation;
an energy consumption amount calculation unit configured to calculate amounts of energies that are consumed by the power source installation and the heat source installation during the energy sustainable target time, based on the operation plans created by the installation operation planning unit;
a load control examination unit configured to change a ratio between heat and electricity that are consumed by the electricity load installation and the heat load installation to reduce the amounts of the consumed energies that are calculated by the energy consumption amount calculation unit, and update, based on the ratio, at least one of the operational method for the electricity load installation, the operational method for the heat load installation, and the operational method for the facility or the region; and
an output unit configured to output the at least one of the operational method for the electricity load installation, the operational method for the heat load installation, and the operational method for the facility or the region that is updated by the load control examination unit,
wherein
at least one of the data obtaining unit, the energy remaining amount obtaining unit, the load prediction unit, the installation operation planning unit, the energy consumption amount calculation unit, the load control examination unit, and the output unit belongs to a first group,
at least one of remaining ones of the data obtaining unit, the energy remaining amount obtaining unit, the load prediction unit, the installation operation planning unit, the energy consumption amount calculation unit, the load control examination unit, and the output unit belongs to a second group, and
the first group is provided outside the facility or the region.

15. An operation planning method of creating operation plans for a power source installation and a heat source installation that operate an electricity load installation and a heat load installation, respectively, that are installed in a facility or a region, the operation planning method comprising:
obtaining at least one of registration data registered in advance as data regarding the facility or the region, input data input from an outside, measurement data measured by a sensor installed in the facility or the region, and external data obtained from the outside via communication;
obtaining a remaining amount of an available energy that is allowed to be used in the facility or the region during an energy sustainable target time indicating a desired duration of continuous operations of the power source installation and the heat source installation;
tentatively determining the operational method for the electricity load installation, the operational method for the heat load installation, and the operational method for the facility or the region based on the obtained data and predicting a load of the electricity load installation and a load of the heat load installation that are required during the energy sustainable target time based on the operational methods;
creating, based on the predicted load of the electricity load installation and the predicted load of the heat load installation, operation plans for the power source installation and the heat source installation;
calculating amounts of energies that are consumed by the power source installation and the heat source installation during the energy sustainable target time, based on the created operation plans;
changing a ratio between heat and electricity that are consumed by the electricity load installation and the heat load installation to reduce the calculated amounts of the consumed energies, and updating, based on the ratio, at least one of the operational method for the electricity load installation, the operational method for the heat load installation, and the operational method for the facility or the region; and
outputting the updated at least one of the operational method for the electricity load installation, the operational method for the heat load installation, and the operational method for the facility or the region.
